(19) United States
(12) Patent Application Publication
(10) Pub. No.: US 2026/0271106 A1
(43) Pub. Date: Sep. 10, 2026

(54) APPARATUS, METHODS, AND SYSTEM FOR ACCESS-AGNOSTIC CONNECTION AND SWITCHING BETWEEN NETWORKS

(71) Applicant: CHARTER COMMUNICATIONS OPERATING, LLC, St. Louis, MO (US)

(72) Inventors: Maulik Vaidya, Escondido, CA (US); Paul L. Russell, JR., Branchburg, NJ (US); Yildirim Sahin, Englewood, CO (US); Umamaheswar A. Kakinada, Greenwood Village, CO (US); Imtiyaz Shaikh, Irving, TX (US); Inmaculada Carrion Rodrigo, Valley Center, CA (US)

(21) Appl. No.: 19/460,143

(22) Filed: Jan. 26, 2026

Related U.S. Application Data
(60) Provisional application No. 63/769,064, filed on Mar. 9, 2025.

(51) Int. Cl. H04W 76/12; H04W 12/03; H04W 76/15; H04W 80/06

(52) U.S. Cl. CPC H04W 76/12; H04W 12/03; H04W 76/15; H04W 80/06

(57) ABSTRACT

Apparatus, methods, and systems for enabling seamless and access-agnostic connectivity and switching between 3GPP and non-3GPP access networks are disclosed. In some embodiments, a Multiplexed Application Substrate over QUIC Encryption (MASQUE) proxy may be deployed within a core or edge network to provide topology hiding and facilitate secure tunneling of both control plane and user plane data. The disclosed architecture supports mutual authentication between a user equipment MASQUE client and a MASQUE proxy, thereby enabling access to network functions without reliance on interworking functions or specific access dependencies. The system may extend service-based interfaces to utilize HTTP/3 and QUIC protocols, treating all traffic as multi-access protocol data units and eliminating distinctions between trusted and untrusted networks. As a result, user equipment may operate in a network-agnostic manner, supporting seamless mobility and session continuity across heterogeneous network environments while maintaining robust security and operational efficiency throughout the end-to-end communication path.

### PRIORITY APPLICATION

This application claims the benefit of priority to U.S. Provisional Patent Application No. 63/769,064, filed Mar. 9, 2025, of the same title which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Technological Field

The present disclosure relates generally to the field of wireless devices and associated networks, and in certain embodiments to architectures, methods, and apparatus for enabling connection and switching of a device between 3GPP access networks and non-3GPP access networks.

### 2. Description of Related Technology

Modern wireless and wireline communication networks have evolved to support a wide variety of services and access modalities, including both 3GPP-based cellular access and non-3GPP access technologies such as Wi-Fi, wireline broadband, and non-terrestrial networks. These networks are increasingly expected to deliver seamless, high-throughput, and low-latency connectivity to user equipment (UE) across diverse environments, ranging from fixed premises to highly mobile scenarios. In current deployments, network architectures often distinguish between so-called “trusted” and “untrusted” access networks, with different authentication, security, and transport mechanisms applied depending on the type of access. For example, 5G systems utilize a range of interworking functions (IWFs) such as N3IWF, TNGF, and W-AGF to bridge non-3GPP accesses to the 5G core network, resulting in increased architectural complexity and operational overhead.

Release 19 forms part of the ongoing 3GPP standardization efforts for 5G and its evolution, building incrementally on the capabilities introduced in earlier releases, including Release 15 (initial 5G), Release 16 (5G enhancements), Release 17, and Release 18 (5G-Advanced). Release 19 is expected to further advance the features of 5G-Advanced and establish foundational elements for the transition toward 6G. As illustrated in FIG. 1, the 3GPP 5GS (5G System) architecture 100 provides a high-level overview of the interconnections and interfaces between user equipment, radio access networks, and a range of core network functions, including but not limited to AMF, SMF, UPF, AUSF, PCF, UDM, NRF, NEF, NSSF, and AF. The figure depicts key interfaces such as N2, N4, and N6, which facilitate the flow of control and user plane data within the 5G architecture.

A primary focus area of Release 19 is the enablement of seamless connectivity between heterogeneous wireless networks. As of January 2026, 3GPP Release 20 is under active development, representing a critical phase in the progression toward 6G. Release 20 builds upon the enhancements of 5G-Advanced, with objectives that include further increasing network capacity, reducing latency, and improving user experience. The evolution to 6G is anticipated to introduce new architectural paradigms and protocol optimizations that will enable more robust support for seamless connectivity and dynamic switching between wireless networks, thereby supporting high-quality end user experiences with minimized service interruption and improved throughput.

### Multiplexed Application Substrate Over QUIC Encryption (MASQUE)

One technology area of particular relevance in this context is Multiplexed Application Substrate over QUIC Encryption (MASQUE). MASQUE is a protocol framework that has been introduced in 5G networks, as depicted in FIGS. 1-5, and is expected to play a significant role in 6G system architectures. MASQUE enables secure and efficient tunneling of internet traffic by utilizing HTTP 3.0 in conjunction with QUIC (Quick UDP Internet Connections), a transport protocol based on user datagram protocol (UDP). This approach allows for the multiplexing of multiple logical connections over a single QUIC tunnel, thereby improving network resource utilization, enhancing security, and supporting higher aggregate throughput.

MASQUE is architected to address limitations in existing tunneling mechanisms by providing a scalable and secure substrate for application data transport. The protocol is capable of supporting diverse traffic types, including UDP, IP forwarding, and HTTP, all encapsulated within a QUIC-based connection. This versatility is particularly advantageous in mobile and high-performance network environments, where the ability to reduce latency, maintain robust connections, and optimize throughput is essential. MASQUE's design facilitates seamless, low-latency communication across heterogeneous network environments, which is a key consideration for both 5G and emerging 6G systems.

In the context of 3GPP networks, MASQUE may be leveraged to facilitate network handovers and interworking between 3GPP and non-3GPP access technologies. As 6G is expected to integrate a broader array of access technologies (including 3GPP, Wi-Fi, satellite, and others), MASQUE's capability to efficiently tunnel data across disparate network infrastructures is anticipated to be a critical enabler. This is particularly relevant for applications such as mobile edge computing, real-time communications, and IoT services, where stringent quality of service (QoS) and low latency requirements must be met.

The implementation of MASQUE within 3GPP networks is supported by standards such as TS 23.501 v19.2.0 (System Architecture for the 5G System), TS 23.502 v19.2.0 (Procedures for the 5G System), and TS 29.501 v19.1.0 (Interfaces and Protocols). Additionally, specifications from the Internet Engineering Task Force (IETF), including RFC 9000 (QUIC) and MASQUE-related drafts, provide technical guidance that aligns with 3GPP's objectives for secure, flexible, and scalable mobile network solutions.

As 6G network development progresses, the integration of MASQUE with advanced transport layers such as QUIC is expected to be essential for supporting the demands of high-bandwidth, latency-sensitive applications, including immersive media, augmented reality (AR), and virtual reality (VR). Furthermore, MASQUE's potential to serve as a foundation for secure tunneling and proxying mechanisms aligns with the security and privacy requirements set forth in 3GPP TS 38.300 (NR Radio Access), ensuring data integrity and confidentiality across multiple network types.

### Unaddressed Issues for Connectivity Between 3GPP Access and Non-3GPP Access Wireless Networks

As user expectations and industry requirements continue to evolve, there is a growing demand for network architectures that are agnostic to the underlying access technology, enabling devices to switch between 3GPP and non-3GPP accesses without dependency on a particular access type. In addition, the proliferation of new services and use cases, such as ultra-reliable low-latency communications, massive machine-type communications, and converged wireline-wireless offerings, has highlighted the limitations of legacy tunneling and transport protocols, as well as the need for unified security and authentication frameworks. Existing solutions may require multiple protocol adaptations, redundant encapsulation, or disparate authentication procedures, which can introduce inefficiencies, increase latency, and complicate network management.

Recent advances in transport protocols, such as the introduction of QUIC and the MASQUE (Multiplexed Application Substrate over QUIC Encryption) framework, have enabled secure and efficient tunneling of traffic over HTTP/3, providing built-in encryption and improved performance characteristics. However, current 5G and earlier architectures have not fully leveraged these capabilities across both control and user planes, nor have they extended service-based interfaces (SBI) to utilize modern transport protocols such as HTTP/3 and QUIC in a unified manner. For example, current 3GPP specifications, including Release 19, do not provide an optimal mechanism for accessing services via non-3GPP access or for enabling seamless switching between 3GPP and non-3GPP access without dependencies on 3GPP access. Existing mechanisms require the use of interworking functions (IWFs) such as N3IWF, TNGF, or W-AGF to facilitate such transitions. These approaches can introduce inefficiencies, including increased latency, reduced throughput, and suboptimal user quality of experience (QoE). As a result, there remains a need for improved system architectures and methods that can provide access-agnostic connectivity, eliminate the distinction between trusted and untrusted networks, and streamline the transport of both control and user plane data using a common, secure, and efficient protocol substrate.

Accordingly, improved apparatus, systems, and methods are desirable that can support seamless switching between 3GPP and non-3GPP accesses, provide network-agnostic operation from the perspective of the user equipment, and reduce architectural dependencies on interworking functions. Such solutions may advantageously leverage MASQUE proxies and (MP)QUIC protocols to enable encrypted, topology-hiding tunnels for both control and user plane traffic, extend service-based architecture principles throughout the network, and unify authentication procedures for all access types. These improvements can facilitate the evolution of next-generation (6G) system architectures, supporting both existing and emerging use cases while reducing complexity and enhancing security and operational efficiency.

### SUMMARY

The present disclosure addresses the foregoing needs by providing, inter alia, methods, apparatus, and systems for enabling seamless, secure, and access-agnostic transition and connectivity between Third Generation Partnership Project (3GPP) access networks and non-3GPP access networks. In various aspects, the disclosed techniques utilize a MASQUE-enabled proxy architecture that may be deployed within a core network, within a radio access network, or at a network edge, thereby enabling unified transport of control plane and user plane communications without reliance on legacy interworking functions such as N3IWF, TNGF, or W-AGF. As described herein, the disclosed architecture enables access-agnostic operation while preserving separation between control plane and user plane functions and maintaining topology hiding of core network elements from user equipment.

In one aspect, a system is provided for enabling seamless transition and connectivity between 3GPP and non-3GPP access networks in an access-agnostic manner. In one embodiment of the system, a MASQUE-enabled client device is implemented to communicate data to at least one MASQUE-enabled node apparatus (including the MASQUE-enabled proxy) using a QUIC-based transport connection. The MASQUE-enabled node apparatus is further implemented to forward the received data to one or more network functions, which are implemented to process the forwarded data. In some implementations of this embodiment, the protocol stack of the MASQUE-enabled client device is enhanced to include MASQUE tunneling functionality that enables the client device to tunnel control plane and/or user plane data to the MASQUE-enabled node apparatus, while the MASQUE-enabled node apparatus provides topology hiding such that network access is independent of whether the underlying access network is a 3GPP access network or a non-3GPP access network. In these implementations, topology hiding ensures that network functions are not directly visible or accessible to the user equipment and that control plane and user plane separation within the core network is maintained.

In various embodiments of the foregoing system aspect, the data communicated between the MASQUE-enabled client device and the MASQUE-enabled node apparatus may include control plane data, user plane data, or combinations thereof. Control plane data may include, by way of non-limiting example, mobility management signaling, session management signaling, authentication signaling, or policy-related information. User plane data may include protocol data units or other service data associated with one or more data sessions. The network functions to which the data is forwarded may include, for example, an access and mobility management function (AMF), a session management function (SMF), a short message service function (SMSF), a policy control function (PCF), a location management function (LMF), or a user plane function (UPF). In some implementations, the MASQUE-enabled client device and the MASQUE-enabled node apparatus perform a mutual authentication process, and secure tunneling of control plane and user plane data is achieved using a protocol stack that includes HTTP, QUIC, and UDP/IP, such as HTTP/3 operating over QUIC.

In some variants of the system aspect, the MASQUE-enabled node apparatus is integrated within a 3GPP radio access network, including a 6G radio access network, to support 3GPP access. In other variants, the MASQUE-enabled node apparatus is disposed within a core network or at a network edge to support non-3GPP access. In such variants, the MASQUE-enabled node apparatus is implemented to receive data from the MASQUE-enabled client device over wireline links, wireless links such as Wi-Fi, or non-terrestrial links. In these implementations, the use of a MASQUE proxy for non-3GPP access obviates the need for interworking functions such as N3IWF, TNGF, or W-AGF. The data may further include control plane or user plane messages that are encrypted and routed using QUIC-based transport to the network functions via service-based interfaces, including N1, N2, or N3, and in some implementations the service-based interfaces of the network functions are based on multipath QUIC rather than HTTP/2.

In some implementations of the foregoing aspects and embodiments, the QUIC-based transport leverages HTTP/3 to eliminate or reduce reliance on intra-PLMN or inter-PLMN IPSec tunnels and to provide transport and security mechanisms aligned with Internet Engineering Task Force (IETF) specifications. The data communicated may include multi-access protocol data units (MA-PDUs), and topology hiding may be achieved by treating all non-3GPP access networks as untrusted from a 3GPP perspective, thereby eliminating distinctions between trusted and untrusted non-3GPP access. In these implementations, the MASQUE-enabled client device may include a common upper-layer interface that is usable for both 3GPP access and non-3GPP access.

In some embodiments, the QUIC connection setup process between the MASQUE-enabled client device and the MASQUE-enabled node apparatus replaces, or functionally obviates for at least a portion of communications, legacy protocols including SCTP, GTP-U, EAP-5G, IKEv2, and IPSec by utilizing multipath QUIC or other QUIC-based transports. In some implementations, header information associated with multipath QUIC and NG-AP includes user equipment to AMF-specific information. In further implementations, a GRE layer is removed from the protocol stack, while GRE header information, such as a QoS flow identifier for uplink traffic or a reflective QoS indicator for downlink traffic, is retained within user plane information. In such implementations, one GRE tunnel per QoS flow identifier per child security association may be supported using multipath QUIC connections. The connection setup process may further include replacing HTTP/2, TLS, and TCP with multipath QUIC and UDP.

In another aspect, a computerized method is provided for utilizing a proxy apparatus to support user equipment communications over a wireless network. In one embodiment, a QUIC connection setup is performed with the user equipment to establish a QUIC data connection, and data is communicated from the user equipment to a network apparatus via the QUIC data connection. In some implementations, the wireless network includes a 3GPP access network, and the proxy apparatus is part of a 3GPP radio access network. The connection setup uses a protocol stack in the user equipment that includes HTTP/3 with an extension identifying the network apparatus, a QUIC layer, and a UDP layer. The data communicated may include control plane data for signaling with an AMF and SMF or user plane data associated with service data adaptation protocol and a user plane function and PDU session anchor.

In other variants, the wireless network includes a non-3GPP access network, and the proxy apparatus is disposed within the core network. In such variants, the connection setup uses a similar protocol stack in the user equipment, and the data communicated includes control plane or user plane data destined for appropriate network functions. The method may further include removing a GRE layer from the protocol stack while retaining GRE header information within user plane data.

In a further aspect, a computerized proxy apparatus is provided that is implemented for data communication with user equipment via a wireless network. In one embodiment, the apparatus includes a processor apparatus and a storage apparatus, with the storage apparatus storing at least one computer program that, when executed by the processor apparatus, causes the apparatus to perform a QUIC connection setup with the user equipment, establish a QUIC data connection, and utilize the connection to communicate authentication request and response messages as part of a mutual authentication process. In some implementations, the computerized proxy apparatus is part of a 3GPP radio access network or is disposed within a core network for non-3GPP access, and replaces or obviates a non-3GPP interworking function.

In some embodiments, a wireless access point is provided within a 6G infrastructure and is implemented to interface with multiple wireless local area network clients and core network functions via a MASQUE proxy located within the core network or at the network edge.

In further aspects, computer-readable apparatus are provided, including non-transitory storage media storing one or more computer programs, such as MASQUE control logic for a client or proxy, which may be implemented in a client device, a local controller, or a node apparatus integrated within a 6G radio access network or as a proxy within a core or edge network. In some implementations, an integrated circuit device implements one or more of the foregoing aspects and may be embodied as a system-on-chip, application-specific integrated circuit, chipset, or multi-logic block FPGA device.

These and other aspects shall become apparent when considered in light of the disclosure provided herein.

### BRIEF DESCRIPTION OF THE DRAWINGS

FIG. 1 is a block diagram illustrating a prior art 5G system architecture including user equipment, a radio access network, and core network functions.

FIG. 2 is a block diagram illustrating a prior art 3GPP system architecture supporting access traffic steering, switching, and splitting (ATSSS) across both 3GPP and non-3GPP access networks.

FIG. 3 is a block diagram illustrating a prior art control plane protocol stack between user equipment, an access network, and core network functions.

FIG. 4 is a block diagram illustrating a prior art user plane protocol stack between user equipment, an access network, and a core network.

FIG. 5 is a block diagram illustrating a prior art service-based interface protocol stack used for communication between network functions in a 3GPP system.

FIG. 6A is a block diagram illustrating an exemplary 6G system architecture leveraging a MASQUE proxy, MASQUE client and QUIC protocols for unified, access-agnostic connectivity across user equipment, access networks, and core network functions.

FIG. 6B is a schematic diagram illustrating the exemplary 6G system architecture of FIG. 6A, leveraging MASQUE Proxy for secure and unified control and user plane communication across 3GPP and non-3GPP access networks.

FIG. 7 is a block diagram illustrating an enhanced 6G control plane protocol stack utilizing MASQUE client and proxy components to enable secure and efficient signaling between user equipment, 3GPP access networks, and core network functions.

FIG. 8 is a block diagram illustrating an enhanced 6G user plane protocol stack utilizing MASQUE client and proxy components to provide secure and efficient data forwarding between user equipment, access networks, user plane functions, and data networks.

FIG. 9 is a block diagram illustrating an enhanced 6G control plane protocol stack between user equipment, a non-3GPP access network, and an access and mobility management function utilizing MASQUE client and proxy components.

FIG. 10 is a block diagram illustrating an enhanced 6G user plane protocol stack between user equipment, a 3GPP access network, a user plane function, and a data network utilizing MASQUE client and proxy components.

FIG. 11A is a schematic diagram illustrating communication between network functions over a 6G service-based interface utilizing an HTTP/3-based transport architecture.

FIG. 11B is a block diagram illustrating protocol stacks of 6G network functions communicating over a service-based interface implemented using MASQUE and Multipath QUIC transport layers.

FIG. 12 is a flow diagram illustrating one embodiment of a method for enabling data transmission between user equipment and one or more network functions using a MASQUE-enabled node.

FIG. 13 is a flow diagram illustrating one embodiment of a method for establishing and maintaining a secure communication tunnel between a user equipment's MASQUE client and a MASQUE proxy using QUIC-based handshake and mutual authentication procedures.

FIG. 14 is a flow diagram illustrating an exemplary method for implementing secure control plane communication between a user equipment and core network functions via a MASQUE-enabled proxy operating over HTTP/3 and QUIC transport.

FIG. 15 is a flow diagram illustrating one embodiment of a method for transmitting encapsulated data units over multiple access links using Multipath QUIC while maintaining session continuity and encryption integrity across concurrent transport sessions.

FIG. 16 is a block diagram illustrating an exemplary embodiment of an enhanced user equipment apparatus implemented for access-agnostic connection and switching between networks in a 6G system.

FIG. 17 is a block diagram illustrating an exemplary embodiment of an enhanced network node or network function apparatus implemented for access-agnostic connection and switching between networks in a 6G system.

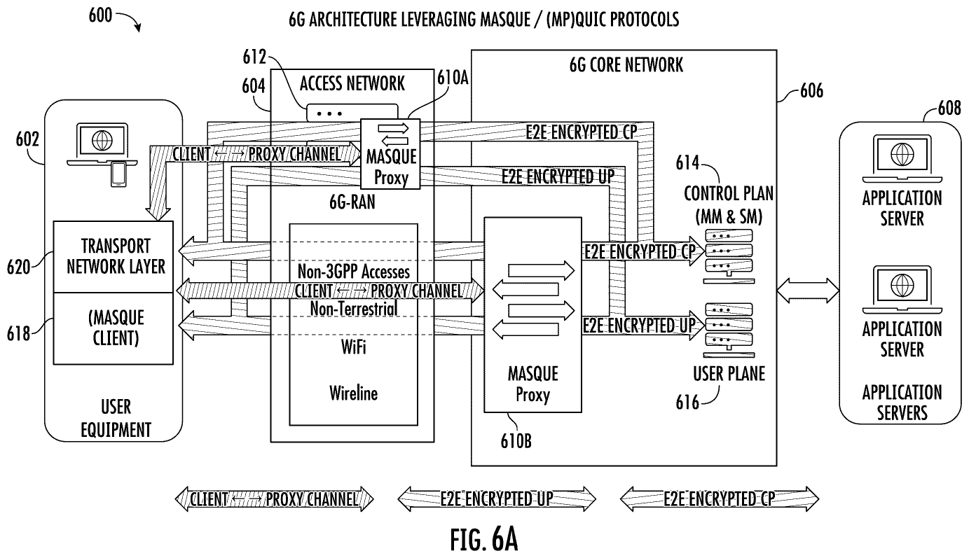

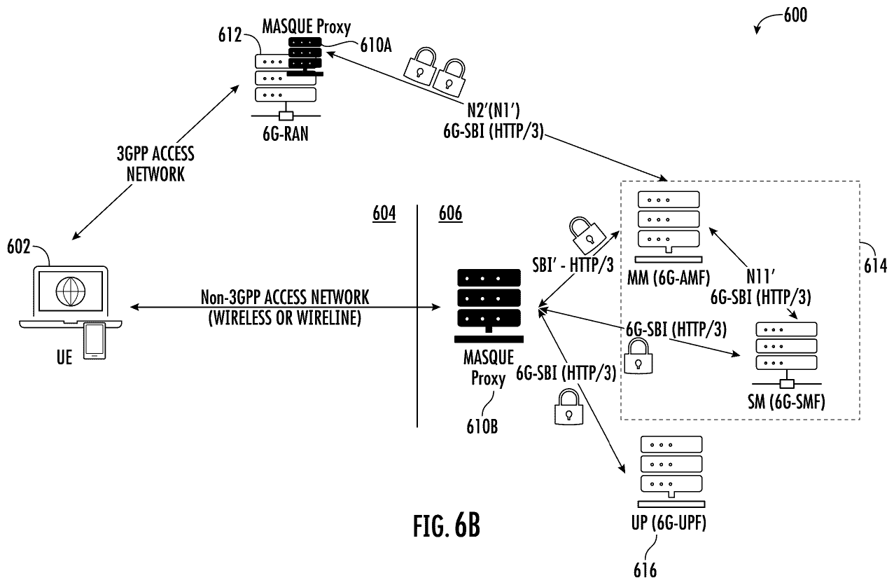

FIGS. 6-17 © Copyright 2025 Charter Communications Operating, LLC. All rights reserved.

### DETAILED DESCRIPTION

Reference is now made to the drawings wherein like numerals refer to like parts throughout.

As used herein, the term “access node” refers generally and without limitation to a network node which enables communication between a user or client device and another entity within a network, such as for example a 3GPP access (e.g., 6G-AN which includes a CBRS node) and non-3GPP access (e.g., trusted, untrusted, and wireline). Trusted/untrusted may include a Wi-Fi, and wireline may include a Cable Modem (CM).

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could include a downloadable Java Xlet™ that runs within the JavaTV™ environment.

As used herein, the terms “client device” or “user device” or “UE” include, but are not limited to, Fifth Generation Residential Gateway (5G-RG), set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, smartphones, and vehicle infotainment systems or portions thereof.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “headend” or “backend” refers generally to a networked system controlled by an operator (e.g., an MSO) that distributes programming to MSO clientele using client devices. Such programming may include literally any information source/receiver including, inter alia, free-to-air TV channels, pay TV channels, interactive TV, over-the-top services, streaming services, and the Internet.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “LTE” refers to, without limitation and as applicable, any of the variants or Releases of the Long-Term Evolution wireless communication standard, including LTE-U (Long Term Evolution in unlicensed spectrum), LTE-LAA (Long Term Evolution, Licensed Assisted Access), LTE-A (LTE Advanced), and 4G/4.5G LTE.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), 3D memory, and PSRAM.

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein, the terms “MSO” or “multiple systems operator” refer to a cable, satellite, or terrestrial network provider having infrastructure required to deliver services including programming and data over those mediums.

As used herein, the terms “MNO” or “mobile network operator” refer to a cellular, satellite phone, WMAN (e.g., 802.16), or other network service provider having infrastructure required to deliver services including without limitation voice and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, LTE/LTE-A/LTE-U/LTE-LAA, 5G NR, WAP, SIP, UDP, FTP, RTP/RTCP, H.323, etc.).

As used herein, the term “network interface” refers to any signal or data interface with a component or network including, without limitation, those of the FireWire (e.g., FW400, FW800, etc.), USB (e.g., USB 2.0, 3.0. OTG), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), LTE/LTE-A/LTE-U/LTE-LAA, Wi-Fi (802.11), WiMAX (802.16), Z-wave, PAN (e.g., 802.15), or power line carrier (PLC) families.

As used herein, the term “MASQUE-enabled node apparatus” refers to a network-side apparatus configured to support Multiplexed Application Substrate over QUIC Encryption (MASQUE) functionality, and includes at least one MASQUE-enabled proxy configured to establish, maintain, or terminate one or more QUIC-based tunnels with a MASQUE-enabled client device. The MASQUE-enabled node apparatus may be implemented within a radio access network, a core network, a network edge, or other network infrastructure, and may further be configured to forward tunneled control plane data, user plane data, or both, to one or more network functions in an access-agnostic manner.

As used herein the terms “5G” and “New Radio (NR)” refer without limitation to apparatus, methods or systems compliant with 3GPP Release 15, and any modifications, subsequent Releases, or amendments or supplements thereto which are directed to New Radio technology, whether licensed or unlicensed.

As used herein the terms “6G” such as in “6G RAN”, “6G-AMF” and “G-SMF”, etc. refer without limitation to apparatus, methods or systems compliant with Release 21 (which will be the first official 6G standard, defining the full 6G system), and Release 21+ (evolution of 6G with refinements and optimizations), and any modifications, subsequent Releases, or amendments or supplements thereto.

As used herein, the term “server” refers to any computerized component, system or entity regardless of form which is adapted to provide data, files, applications, content, or other services to one or more other devices or entities on a computer network.

As used herein, the term “storage” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “users” may include without limitation end users (e.g., individuals, whether subscribers of the MSO network, the MNO network, or other), the receiving and distribution equipment or infrastructure such as a CPE/FWA or CBSD, venue operators, third party service providers, or even entities within the MSO itself (e.g., a particular department, system or processing entity).

### Overview

The present disclosure relates to improved architectures, methods, and apparatus for enabling seamless and access-agnostic wireless service connectivity, allowing a device to transition between 3GPP access networks and non-3GPP access networks without reliance on a particular access type. In some embodiments, user equipment and access network protocol stacks are enhanced to incorporate a MASQUE client or proxy that may be deployed within a 6G radio access network, within a core network, or at a network edge. This arrangement enables tunneling of control plane and user plane information-including mobility management, session management, and related signaling-directly to core network functions, while reducing or obviating reliance on traditional interworking functions such as N3IWF, TNGF, or W-AGF.

In various embodiments, the disclosed architecture leverages modern transport and security protocols, including HTTP/3 and QUIC, as foundational mechanisms wherever feasible. These protocols provide integrated security and encryption capabilities, such as those based on QUIC and Transport Layer Security (TLS) 1.3, and may reduce reliance on separate tunneling or gateway-based security mechanisms used in conventional deployments. Through the use of MASQUE proxies, the system provides topology hiding within both the access network and the core network, enabling the user equipment to operate in a network-agnostic manner and without dependency on 3GPP access when utilizing non-3GPP access networks.

In some embodiments, the architecture removes distinctions between trusted and untrusted non-3GPP networks by treating all non-3GPP access as untrusted from the perspective of the core network and by supporting a unified authentication mechanism. Under this model, the user equipment operates independently of 3GPP access when connected via non-3GPP access and is capable of seamless switching between access types while maintaining security and session continuity.

In certain embodiments, a MASQUE proxy provides topology hiding within the access network and the core network, and mutual authentication is performed between a MASQUE client in the user equipment and the MASQUE proxy using operator-provisioned credentials and QUIC-based handshake procedures. This process enables secure establishment of communication channels for both control plane and user plane data.

The disclosed framework enhances both control plane and user plane protocol stacks by incorporating MASQUE client or proxy functionality in the user equipment and relevant network nodes, such as access network components for 3GPP access or core network components for non-3GPP access. Control plane and user plane messages may be encrypted and transported via QUIC-based tunnels to appropriate network functions through service-based interfaces. The framework further supports extension of service-based interfaces to user plane communications, treatment of protocol data units as multi-access data units, and preservation of established boundaries between network component providers. In some embodiments, a common upper-layer interface is provided within the user equipment for both 3GPP and non-3GPP access, enabling unified operation across heterogeneous network environments.

In some variants, protocol stacks are streamlined by using QUIC-based transport mechanisms, including multipath QUIC where available, in place of or to reduce reliance on legacy transport, tunneling, or signaling protocols for at least certain transport, signaling, or deployment contexts. Network signaling and user plane data may be transmitted directly over encrypted QUIC tunnels, and service-based interfaces between network functions may similarly transition from legacy transport stacks to architectures based on HTTP/3 and QUIC, supporting efficient and secure communication throughout the network.

The MASQUE proxy may be implemented as a logical peer within various network entities, supporting flexible deployment scenarios such as communication between user equipment and control plane functions, user equipment and user plane functions, or between network nodes. In certain variants, the system supports tunneling of non-access stratum signaling within user plane transport for non-3GPP access and adopts a loosely coupled approach to quality-of-service adaptation, allowing each access network to perform its own mapping to a 3GPP quality-of-service model. By employing a unified QUIC-based transport framework, the disclosed architecture supports efficient, resilient, and secure wireless service delivery while facilitating seamless mobility and improved user experience across both cellular and non-cellular access technologies.

### Detailed Description of Exemplary Embodiments

Exemplary embodiments of the apparatus and methods of the present disclosure are now described in detail. While these exemplary embodiments are described in the context of the previously mentioned wireless access nodes (e.g., gNBs, 6G-AN) associated with or supported at least in part by a managed network of a service provider (e.g., MSO and/or MNO networks), other types of radio access technologies (“RATs”), other types of networks and architectures that are configured to deliver digital data (e.g., text, images, games, software applications, video and/or audio) may be used consistent with the present disclosure. Such other networks or architectures may be broadband, narrowband, or otherwise, the following therefore being merely exemplary in nature.

It will also be appreciated that while described generally in the context of a network providing service to a customer or consumer or end user or subscriber (i.e., within a prescribed service area, venue, or other type of premises), the present disclosure may be readily adapted to other types of environments including, e.g., outdoors, commercial/retail, or enterprise domain (e.g., businesses), or even governmental uses. Yet other applications are possible.

Also, while certain aspects such as certain types of PDU sessions are described primarily in the context of the well-known Internet Protocol (described in, inter alia, Internet Protocol DARPA Internet Program Protocol Specification, IETF RFC 791 (September 1981) and Deering et al., Internet Protocol, Version 6 (IPv6) Specification, IETF RFC 2460 (December 1998), each of which is incorporated herein by reference in its entirety), it will be appreciated that the present disclosure may utilize other types of protocols (and in fact bearer networks to include other internets and intranets) to implement the described functionality.

Further, while some aspects of the present disclosure are described in detail with respect to so-called 6G (mostly relating to normative specifications to be specified in 3GPP Release 21 and onwards), such aspects are in some cases access technology “agnostic” and hence may be used across different access technologies, and can be applied to, inter alia, any type of P2MP (point-to-multipoint) or MP2P (multipoint-to-point) technology, including e.g., Qualcomm Multefire.

Other features and advantages of the present disclosure will immediately be recognized by persons of ordinary skill in the art with reference to the attached drawings and detailed description of exemplary embodiments as given below.

### Extant Architectures and Protocol Stacks

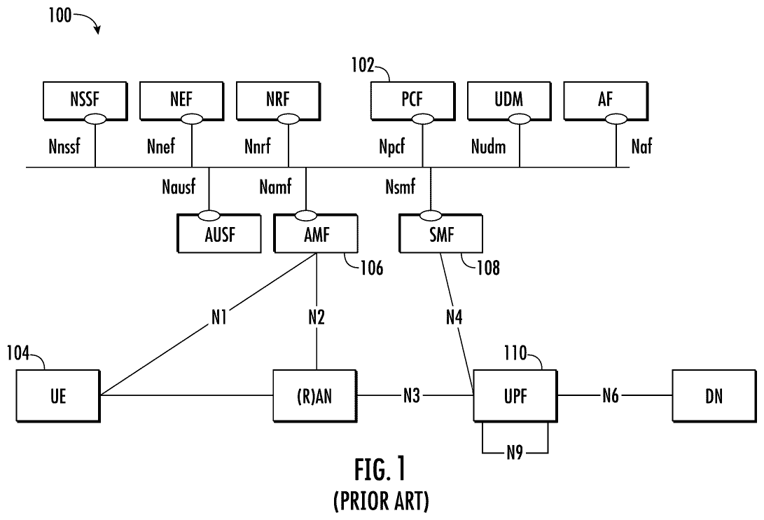

FIG. 1 illustrates a prior art 5G system architecture 100 comprising user equipment 104, a radio access network (RAN), and a plurality of core network functions 102 interconnected via standardized interfaces. The user equipment 104 is configured to communicate with the RAN, which in turn interfaces with the core network functions 102 through the N2 interface 106 for control plane signaling and the N3 interface for user plane data. The core network functions 102 include, by way of example, the Access and Mobility Management Function (AMF), Session Management Function (SMF), User Plane Function (UPF), Policy Control Function (PCF), Network Exposure Function (NEF), Network Repository Function (NRF), Authentication Server Function (AUSF), Unified Data Management (UDM), and Application Function (AF), each supporting specific roles in mobility management, session management, policy enforcement, authentication, and service exposure. The UPF is further connected to external data networks (DN) via the N6 interface 110, and to the SMF via the N4 interface 108, thereby facilitating the routing and forwarding of user data packets between the user equipment 104 and external networks.

The N2 interface 106 is a standardized interface for control plane signaling between the RAN and the AMF, while the N4 interface 108 is used for control and management signaling between the SMF and the UPF, and the N6 interface 110 provides connectivity between the UPF and external data networks. Examples of core network functions may include, without limitation, network elements responsible for mobility management, session establishment, policy control, and user authentication. The depicted architecture 100 exemplifies the separation of control and user plane functions and highlights the reliance on multiple standardized interfaces for interconnection and interoperability within the 5G system.

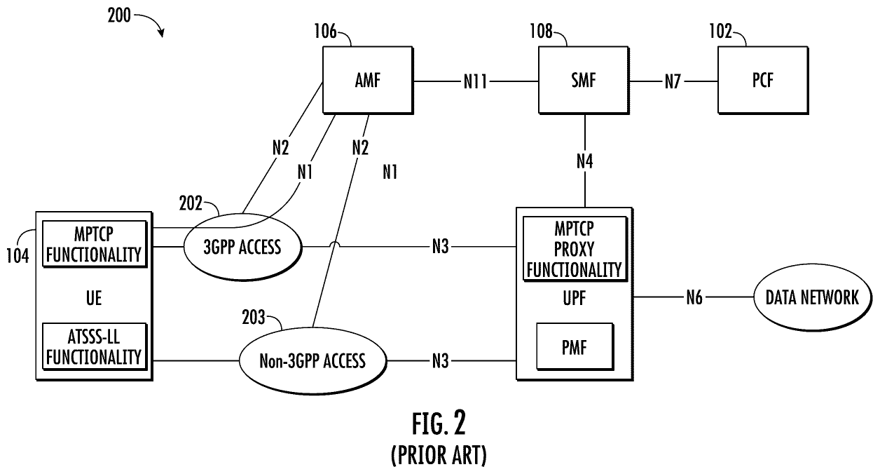

FIG. 2 illustrates a prior art system architecture 200 for a 5G network supporting both 3GPP access 202 and non-3GPP access 203, thereby enabling user equipment 104 to connect to core network functions 102 through multiple access modalities. In this sample architecture, the user equipment 104 is configured with both MPTCP functionality and ATSSS-LL functionality, allowing it to interface with either 3GPP access 202 or non-3GPP access 203.

The 3GPP access 202 and non-3GPP access 203 each provide connectivity to the Access and Mobility Management Function (AMF) of the core network functions 102 via the N2 interface 106 for control plane signaling and the N3 interface for user plane data. The SMF is connected to the UPF via the N4 interface 108, and to the PCF via the N7 interface, while the UPF provides connectivity to external data networks through the N6 interface. The architecture 200 further supports multipath transport and access traffic steering, switching, and splitting at both the user equipment 104 and the UPF, as indicated by the inclusion of MPTCP and ATSSS-LL functionality.

This prior art system architecture 200 exemplifies the integration of both 3GPP and non-3GPP accesses within a unified core network, while relying on multiple standardized interfaces and protocol adaptations to support seamless connectivity and service continuity for user equipment 104.

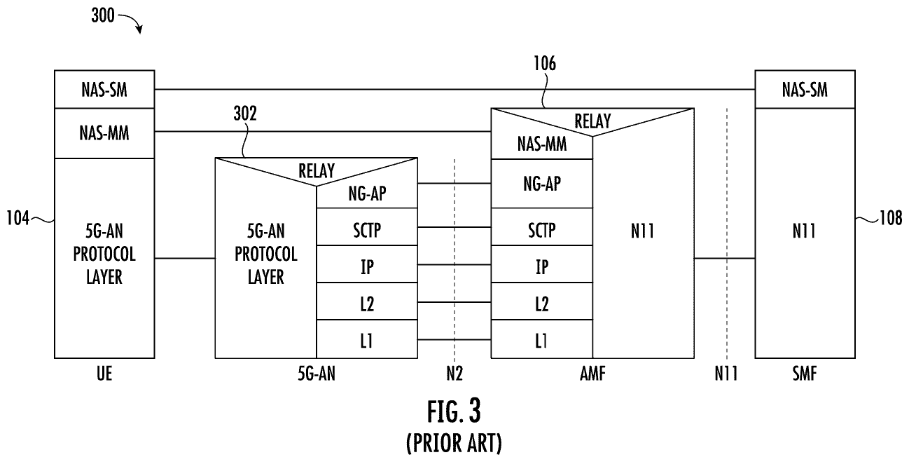

FIG. 3 illustrates a prior art control plane protocol stack diagram 300 depicting the signaling and protocol layering between user equipment 104, an access network, and core network functions within a 5G system. As shown, the user equipment 104 is configured with protocol layers supporting NAS-SM and NAS-MM, which are transmitted through the access network's protocol layers to the Access and Mobility Management Function (AMF) and Session Management Function (SMF) within the core network. The access network includes a relay function 302, which facilitates the forwarding of control plane messages between the user equipment 104 and the core network functions via the N2 interface 106. The relay function 302 is responsible for transparently forwarding NAS signaling and other control messages between the user equipment and the core network, enabling seamless communication across the N2 interface 106. The N2 interface 106 is a standardized control plane interface that connects the access network to the AMF, supporting the exchange of signaling messages such as registration, mobility management, and session establishment. The core network functions, including the AMF and SMF, are further interconnected via the N4 interface 108, which is used for control and management signaling between the SMF and the User Plane Function (UPF).

The depicted architecture exemplifies the separation of user and control plane signaling and highlights the reliance on standardized relay and interface functions to provide interoperability and service continuity within the prior art 5G system.

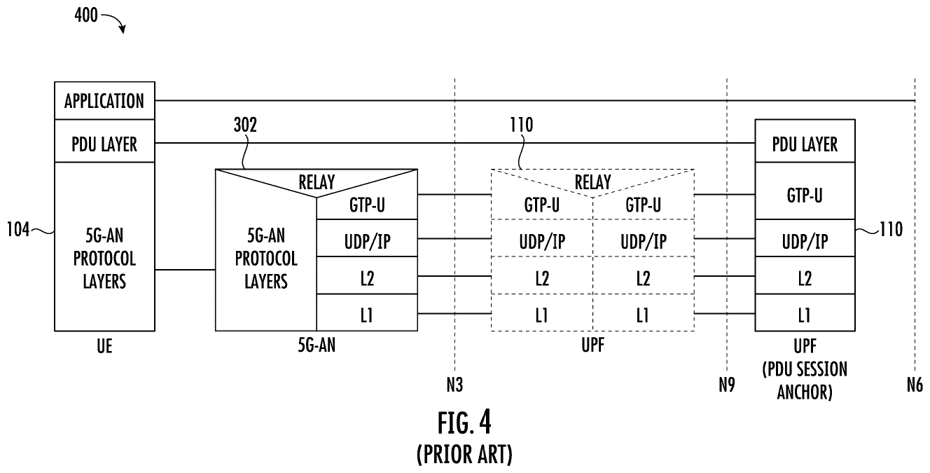

FIG. 4 illustrates a prior art user plane protocol stack 400 depicting the arrangement of protocol layers and interfaces between user equipment 104, an access network, and core network entities within a conventional 5G system. As shown, the user equipment 104 comprises an application layer, a protocol data unit (PDU) layer, and a set of 5G access network (5G-AN) protocol layers, which collectively enable the encapsulation and transmission of user data toward the core network. The access network includes a relay function 302, which is responsible for forwarding user plane data between the user equipment 104 and the core network, thereby facilitating seamless communication across the N3 interface. The relay function 302 is a logical or physical component within the access network that transparently forwards user plane packets between the user equipment and the user plane function (UPF) of the core network. Examples of relay functions may include, without limitation, protocol relays implemented in next-generation radio access networks (NG-RAN), evolved universal terrestrial radio access networks (E-UTRAN), or non-3GPP access gateways. The user plane protocol stack 400 further includes the UPF, which is connected to the access network via the N3 interface and to external data networks via the N6 interface 110.

In this prior art architecture, user plane data originating from the application layer of the user equipment 104 is encapsulated within the PDU layer and traverses the 5G-AN protocol layers before being relayed by the access network and forwarded through the UPF to the appropriate data network via the N6 interface 110. The depicted protocol stack 400 exemplifies the separation of user plane functions from control plane signaling and highlights the reliance on standardized interfaces and relay mechanisms to facilitate end-to-end user data transport within legacy 5G systems.

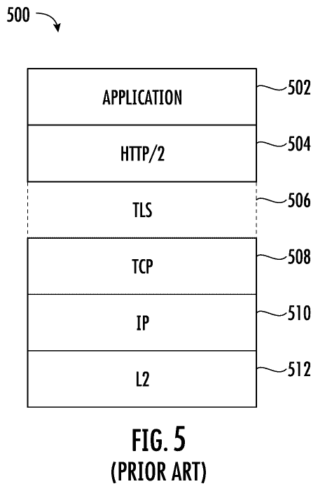

FIG. 5 illustrates a prior art service-based interface (SBI) protocol stack 500 as utilized in conventional 5G system architectures for communication between network functions. The depicted protocol stack 500 comprises a plurality of protocol layers, including an application layer 502, an HTTP/2 layer 504, a transport layer security (TLS) layer 506, a transmission control protocol (TCP) layer 508, an internet protocol (IP) layer 510, and a layer 2 protocol 512. The application layer 502 is responsible for the execution and management of service-based applications and network function services within the core network.

The HTTP/2 layer 504 provides the underlying transport for application messages, supporting multiplexed streams and efficient delivery of service requests and responses. The TLS layer 506 ensures the confidentiality and integrity of messages exchanged over the HTTP/2 connection by providing cryptographic security at the transport layer. The TCP layer 508 provides reliable, connection-oriented transport for upper-layer protocols, ensuring ordered delivery and retransmission of lost packets. The IP layer 510 is responsible for addressing and routing packets across the network infrastructure. The layer 2 protocol 512 provides data link layer functionality, facilitating the reliable transmission of frames over physical network media.

In the prior art, the service-based interfaces utilize HTTP/2 with JSON serialization at the application layer, with security provided by TLS, and transport by TCP/IP over the underlying data link. This protocol stack 500 exemplifies the layered approach to network function communication in legacy 5G systems, highlighting the reliance on HTTP/2, TLS, and TCP for secure and reliable service-based interactions between core network entities.

### Network Architecture and Protocol Stacks

FIG. 6A is a functional block diagram illustrating one exemplary embodiment of a 6G system architecture 600 that leverages MASQUE and QUIC (and, where desired, multipath QUIC (MPQUIC)) to support access-agnostic connection and switching among heterogeneous access networks, while preserving secure tunneling for both control plane (CP) and user plane (UP) communications. The architecture 600 includes user equipment (UE) 602, an access network (AN) 604, a 6G core network (6GCN) 606, and one or more application servers 608.

In this arrangement, the UE 602 includes a transport network layer 620 and a MASQUE client 618. The MASQUE client 618 may be disposed within, or logically associated with, the transport network layer 620 so that the UE can establish secure tunnels for communications traversing the access network 604 toward the 6G core network 606. The access network 604 supports multiple access types, including a 3GPP access (e.g., a 6G-RAN) as well as non-3GPP accesses such as non-terrestrial, Wi-Fi, and wireline accesses, enabling flexible connectivity options for the UE 602.

During operation, the UE-side MASQUE client 618 establishes an encrypted MASQUE/QUIC tunnel using HTTP/3 over QUIC (optionally MPQUIC) to a MASQUE proxy 610. The proxy functionality may be deployed at more than one location—e.g., within the access network 604 and/or within the 6G core network 606—so that different deployment models can be supported without changing the basic tunneling paradigm.

Within the 6G core network 606, control-plane traffic 614 and user-plane traffic 616 are handled and routed separately. CP traffic (including mobility- and session-related signaling such as mobility management and session management) is delivered to appropriate core functions, while UP traffic carries user data and is routed through the core for delivery to external networks and/or application servers 608. MASQUE/QUIC tunneling provides a common secure substrate for both classes of traffic, allowing CP and UP messages to be encrypted and conveyed via QUIC transport to appropriate network functions through service-based interfaces (SBIs), including interfaces such as N1, N2, and N3.

Topology hiding is provided by the MASQUE proxy functionality so that, from the UE's perspective, the network appears access-agnostic. Relatedly, the architecture can be arranged to eliminate a distinction between “trusted” and “untrusted” access networks by treating non-3GPP access as untrusted from a 3GPP perspective, thereby enabling a single non-3GPP authentication mechanism. MASQUE proxy endpoints may also be implemented as peer pairs across different logical entities—such as UE↔AMF, UE↔UPF, and access node↔core node pairings—so that tunneling and routing remain consistent with the access-agnostic model across a range of deployments.

FIG. 6B is a schematic diagram illustrating one exemplary embodiment of the 6G system architecture 600 of FIG. 6A, shown in greater structural and functional detail to highlight MASQUE-based tunneling, QUIC-based transport, and access-agnostic control and user plane communication across both 3GPP and non-3GPP access networks.

Here, the UE 602 is configured to selectively connect to either a 3GPP access network (e.g., a 6G radio access network (6G-RAN) 612) or a non-3GPP access network (including, without limitation, wireless local area networks, wireline networks, and non-terrestrial access systems). The UE includes MASQUE client functionality (described with reference to FIG. 6A) that operates with the transport network layer to encapsulate protocol data for transmission over QUIC-based tunnels.

The illustrated 6G-RAN 612 includes a MASQUE proxy 610A disposed within, or logically associated with, the access network to provide secure tunneling, topology abstraction, and forwarding of encapsulated protocol data originating at the UE 602. The proxy 610A receives encapsulated control-plane and user-plane traffic over QUIC-based transport and forwards that traffic toward the 6G core network 606.

Within the 6G core network 606, an additional MASQUE proxy 610B is shown. Proxy 610B may terminate MASQUE tunnels originating from the access network or, depending on deployment, tunnels established directly from the UE 602. Functionally, 610B can serve as an aggregation and forwarding point for encrypted tunnels established across multiple access types, and it separates and routes control-plane traffic 614 and user-plane traffic 616 to appropriate core network functions based on protocol type and destination.

On the control-plane side, network functions responsible for mobility management and session management (e.g., a 6G-AMF and a 6G-SMF) communicate using service-based interfaces that operate over HTTP/3 and QUIC-based transport, allowing control-plane signaling encapsulated by the UE MASQUE client to be delivered through the MASQUE proxies without requiring access-specific interworking functions. On the user-plane side, traffic is anchored at a 6G user plane function (6G-UPF), with user-plane data generated by the UE encapsulated using MASQUE over QUIC and delivered to the 6G-UPF via the access-network proxy 610A and/or the core-network proxy 610B, after which the 6G-UPF forwards user data toward external networks and application servers 608.

The architecture further extends service-based interfaces to support both control-plane and user-plane communication, so that signaling and user data are transported over a unified QUIC-based substrate. In one such arrangement, traffic conveyed between the UE 602 and the 6G core network 606 is treated as multi-access protocol data units (MA-PDUs) for consistent handling regardless of access technology. This same unifying approach can be paired with the assumption that non-3GPP access is untrusted (from a 3GPP perspective) and a single non-3GPP authentication framework, which supports a common upper-layer interface within the UE for both 3GPP and non-3GPP access and simplifies onboarding and mobility across heterogeneous access technologies.

In operation, control-plane and user-plane messages are encapsulated by the MASQUE client, encrypted and transported over QUIC, routed through proxy 610A and/or proxy 610B, and delivered to the appropriate network functions via service-based interfaces such as N1, N2, or N3, thereby supporting access-agnostic communication, secure end-to-end transport, and protocol unification across 3GPP and non-3GPP domains without reliance on legacy interworking gateways.

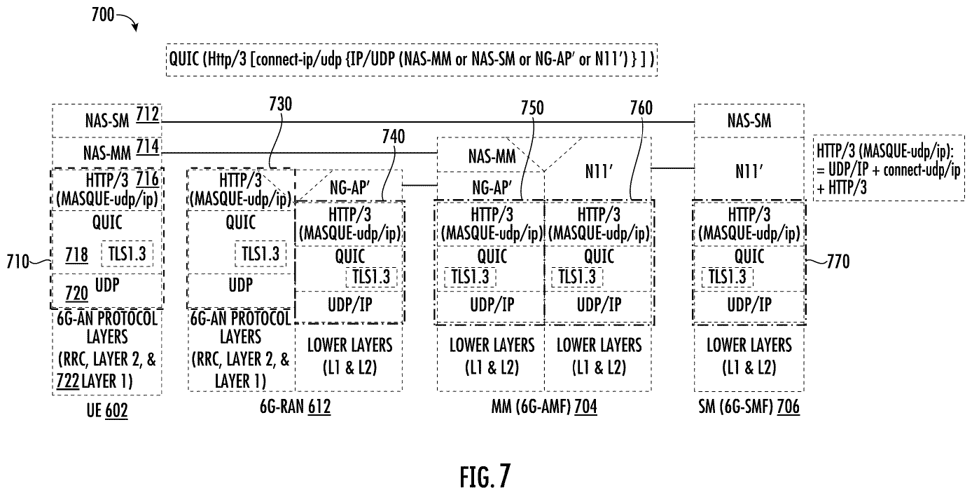

FIG. 7 is a protocol stack diagram illustrating one embodiment of an enhanced 6G control plane architecture 700 utilizing MASQUE client/proxy functionality and QUIC (optionally MPQUIC) to carry signaling between the UE 602, the 6G-RAN 702, and core control-plane functions including mobility management (MM; 6G-AMF 704) and session management (SM; 6G-SMF 706).

The UE 602 includes NAS signaling layers (NAS-SM 712 and NAS-MM 714) together with a secure transport stack that includes HTTP/3 (MASQUE-udp/ip) 716, TLS 1.3 718, and UDP 720, with 6G access network protocol layers 722 shown separately. Control-plane signaling is thus carried over QUIC (or MPQUIC) using HTTP/3 MASQUE encapsulation, enabling NAS and related signaling to be transported end-to-end without dependence on legacy transport choices.

On the access side, the 6G-RAN 702 includes both 6G-AN protocol layers and MASQUE/QUIC stacks capable of relaying or terminating tunnels depending on deployment. As used in this context, relaying of information by a MASQUE-enabled proxy to another MASQUE-enabled proxy is performed via a nested tunnel, such that an outer MASQUE tunnel encapsulates an inner MASQUE tunnel rather than merely forwarding traffic in a single tunnel context. The diagram illustrates a MASQUE-related stack 730 and a QUIC-related stack 740 enabling carriage of signaling toward the core, and also depicts an NG-AP′ (or related signaling) association conveyed over the QUIC/HTTP-3 substrate. Within the core network, stacks for the 6G-AMF 704 and 6G-SMF 706 (including stacks 750, 760—e.g., for an N11′ signaling interface—and 770) likewise include layers such as HTTP/3 (MASQUE-udp/ip), QUIC, TLS 1.3, and UDP/IP, with lower layers indicated as L1 & L2, illustrating a unified approach in which both access signaling and SBI communications operate over a QUIC-based transport substrate.

As used herein, NG-AP′ refers to NG Application Protocol (NG-AP) signaling that is functionally equivalent to standardized NG-AP but is encapsulated and transported using a QUIC-based transport stack, such as HTTP/3 over QUIC, rather than using SCTP. As used herein, N11′ refers to signaling functionally corresponding to the standardized N11 service-based interface between access and session management functions, wherein such signaling is conveyed using a QUIC-based transport architecture instead of a conventional HTTP/2-over-TCP transport.

More specifically, in some embodiments, a QUIC connection setup process can be used to replace or functionally obviate certain legacy transport and security mechanisms for control-plane signaling; for example, SCTP may be replaced by QUIC or MPQUIC in connection setup and/or transport for signaling. That is, the Stream Control Transmission Protocol used for NG-AP signaling between an access network and a core network control function can be replaced, or functionally obviated for at least a portion of NG-AP transport, by QUIC-based transport in which NG-AP signaling messages are encapsulated and transported using HTTP/3 over QUIC (or MPQUIC), thereby providing reliable, encrypted, multiplexed delivery of control-plane signaling without reliance on SCTP associations. QUIC-based NG-AP transport may be used selectively (e.g., for particular access types, sessions, or deployments), while SCTP-based NG-AP transport may be retained for backward compatibility or interworking with legacy network elements.

The MASQUE/QUIC substrate also supports secure routing of CP messages to appropriate network functions via SBIs (e.g., N1/N2/N3) and, with MASQUE proxy functionality, can provide topology hiding and access-agnostic UE signaling over either 3GPP or non-3GPP access. As an aid to describing HTTP/3-based service communication within a 6G service-based architecture, a URI-template style structure may be used to define how services within the 6G core interact using HTTP/3 for service discovery, routing, and/or inter-service communication. In that context, the “protocol” parameter may refer to a MASQUE proxy mode such as connect-udp or connect-ip that indicates the payload encapsulated by the HTTP datagram, and exemplary request components may be carried in an HTTP/3 header frame within QUIC streams, including pseudo-header fields such as :method=CONNECT, :protocol=connect-udp/ip, :scheme=https, with :path identifying a target service (e.g., AMF.domain.com or SMF.domain.com) and :authority identifying a proxy domain (e.g., 6G-RAN.proxy.domain.com). The CONNECT method establishes an encrypted tunnel or session, and the same underlying CONNECT procedure can be reused for different network functions or services (e.g., SMF, AMF, and/or proxy endpoints) while leveraging the HTTPS scheme for protected transport.

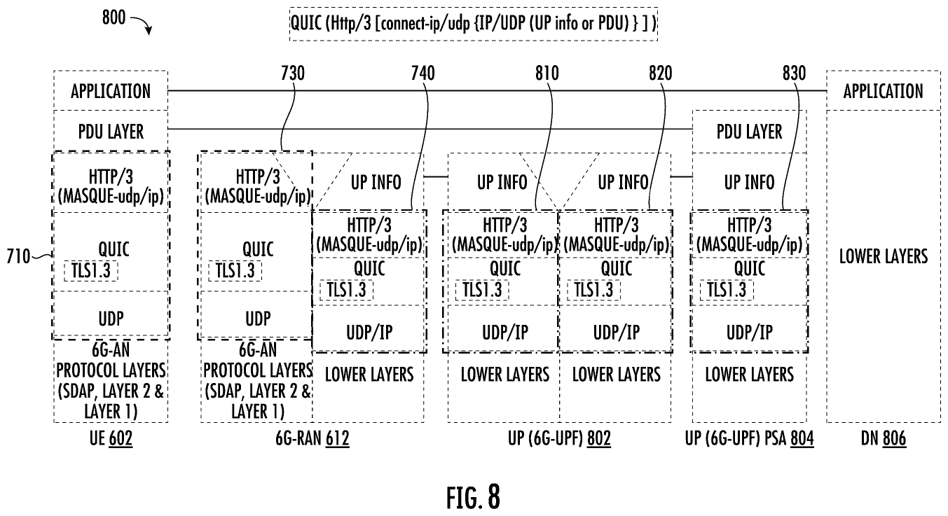

FIG. 8 is a protocol architecture diagram illustrating one exemplary embodiment of an enhanced 6G user plane (UP) architecture 800 employing MASQUE and QUIC (optionally MPQUIC) to transport user-plane data between UE 602, the 6G-RAN 702, one or more user plane functions (6G-UPF 802), a PDU session anchor (6G-UPF PSA 804), and a data network (DN) 806.

The UE 602 includes an application layer and a PDU layer, above which a MASQUE/QUIC stack is shown (e.g., HTTP/3 (MASQUE-udp/ip), QUIC, TLS 1.3, and UDP), while the UE also retains 6G-AN protocol layers (including SDAP and lower layers). The access network similarly includes MASQUE/QUIC stack components enabling carriage of user-plane information and/or PDUs toward the core user-plane functions. “UP info” blocks (e.g., 810, 820, 830) illustrate that user-plane data and/or associated user-plane information may be carried over the QUIC substrate, with user-plane transport proceeding via QUIC using HTTP/3 MASQUE semantics (e.g., HTTP/3 [connect-ip/udp {IP/UDP (UP info or PDU)}]) to tunnel UDP/IP payloads and associated information.

As explained supra, a QUIC connection setup process and transport can replace GTP-U with QUIC or MPQUIC for user-plane transport. References herein to a protocol being “replaced” describe embodiments in which the MASQUE/HTTP/3/QUIC substrate is used in place of one or more legacy transport, tunneling, and/or security mechanisms for at least certain traffic types, interfaces, or deployments; in other deployments, legacy mechanisms may be retained for backward compatibility, interworking, phased migration, roaming, regulatory constraints, or operator policy, and the QUIC-based substrate may be used in parallel or selectively (e.g., per interface, per session, per flow, per access type, or per network slice).

Since QUIC includes integrated security (e.g., TLS 1.3), HTTP-based protocols such as HTTP/3 over QUIC can also be used to obviate the need for certain IPSec tunnel arrangements. HTTP/3 (MASQUE-udp/ip) may be understood as including UDP/IP together with a connect-udp/ip MASQUE mode and HTTP/3 semantics, and may be expressed in one illustrative notation as “UDP/IP+connect-udp/ip+HTTP 3.0.” An exemplary request used to establish an encrypted tunnel/session for user-plane transport may be defined using pseudo-header parameters such as :method=CONNECT, :protocol=connect-udp/ip, :scheme=https, with :path identifying a target such as a PDU session anchor (e.g., PSAUPF.proxy.domain.com), indicating initiation of CONNECT over UDP/IP using an HTTPS scheme and specifying a path to a 6G-UPF PSA via a MASQUE proxy.

Throughout this transport modernization, the lower layers of the 6G access network can remain preserved and operate without modification, maintaining compatibility with existing access technologies and minimizing redesign. Relevant 6G-AN layer-2 and related layers may include MAC, RLC, PDCP, and RRC for control-plane transport, or SDAP for user-plane transport, continuing to provide physical/link-layer processing and radio access/connectivity functions beneath the MASQUE/QUIC overlay.

The UE may include a MASQUE client and the access network may include a corresponding MASQUE proxy (e.g., within a 6G-RAN), enabling direct tunneling of PDUs through an encrypted, multiplexed channel from the UE toward the UPF; one illustrative encapsulation chain is UDP/IP→connect-udp/IP→HTTP 3.0→QUIC→UDP. This can bypass intermediate encapsulation mechanisms such as GTP-U, reducing overhead while maintaining security and session integrity, and can include transmission of UP-related information (e.g., QoS indicators, session identifiers, and/or flow descriptors) over QUIC or MPQUIC transport.

Benefits that may follow include, inter alia, eliminating GTP-U overhead, supporting QoS handling (e.g., by embedding QFI and RQI within QUIC/MPQUIC headers), enhancing security through MASQUE and QUIC/MPQUIC encryption/authentication, lowering latency by enabling direct PDU transmission through MASQUE proxies, and simplifying user-plane design by removal of GRE and GTP-U encapsulation layers where such layers are not used.

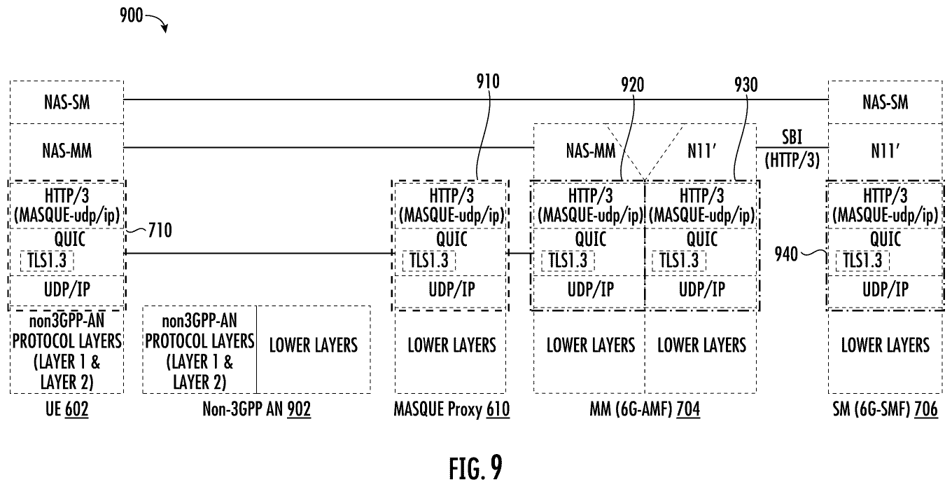

FIG. 9 is a functional block/protocol stack diagram illustrating one exemplary embodiment of an enhanced 6G control plane protocol stack 900 between the UE 602, a non-3GPP access network (non-3GPP AN 802), a MASQUE proxy, and core control-plane functions including MM (6G-AMF 704) and SM (6G-SMF 706).

The UE 602 includes NAS layers (NAS-MM and NAS-SM) and a transport/security stack including HTTP/3 (MASQUE-udp/ip), QUIC, TLS 1.3, and UDP/IP that operates over the non-3GPP access network's underlying protocol layers (e.g., Layer 1 and Layer 2). Those non-3GPP lower layers remain in place, while the MASQUE/QUIC overlay provides an access-agnostic secure transport substrate. As used herein, “QUIC” refers to a QUIC-based transport session that may be implemented as a single-path QUIC connection or, where supported, as a multipath or multi-link QUIC connection (MPQUIC); unless explicitly stated otherwise, references to “(MP)QUIC” encompass both single-path and multipath/multi-link implementations, and multipath operation is optional where a single access link is used or multipath support is not provided.

A MASQUE proxy is logically interposed between the UE and the core functions to provide secure tunneling and routing, and the core functions include corresponding QUIC/HTTP-3 MASQUE stacks so that NAS and related signaling can traverse from the UE through the non-3GPP access and the MASQUE proxy to the appropriate core functions. Control-plane (and, where desired, user-plane) messages can be encrypted and routed by QUIC transport to the proper network functions via SBIs (e.g., N1/N2/N3). By using this MASQUE proxy approach for non-3GPP access, the architecture obviates a need for interworking functions such as N3IWF, TNGF, or W-AGF while maintaining an access-agnostic UE experience.

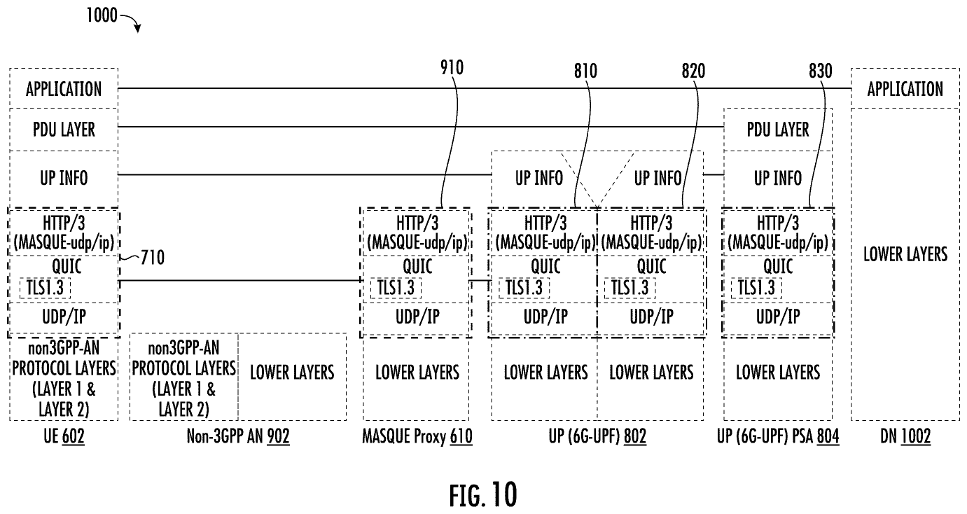

FIG. 10 is a functional block/protocol stack diagram illustrating one embodiment of an enhanced 6G user plane protocol architecture 1000 between UE 602, non-3GPP AN 802, a MASQUE proxy 610, UP (6G-UPF 802), a UP PDU session anchor (6G-UPF PSA 804), and a data network (DN) 1002.

The UE 602 includes an application layer and a PDU layer and uses a transport/security stack including HTTP/3 (MASQUE-udp/ip), QUIC (or MPQUIC), TLS 1.3, and UDP/IP to carry user-plane traffic over the non-3GPP access network's lower protocol layers. MASQUE proxy 610 supports tunneling and forwarding of user-plane traffic from the UE toward the UPF 802 and UPF PSA 804. In this context, a QUIC connection setup process and transport can replace GTP-U with QUIC or MPQUIC, enabling user-plane PDUs (and associated UP information) to be carried within the QUIC/HTTP-3 MASQUE substrate rather than via conventional GTP-U tunneling; stated another way, GTP-U may be replaced for at least a portion of user-plane transport by QUIC/MPQUIC while still supporting encryption, multiplexing, and optional multipath capabilities.

The user-plane connection setup can also remove a GRE layer while still preserving GRE header information within user-plane information. One disclosed example is preserving QoS-related metadata such as QFI (QoS Flow Identifier) in uplink (UL) from the UE toward an interworking context and RQI (Reflective QoS Indicator) in downlink (DL). “GRE header information” is used as a convenient illustration of such QoS-related metadata; equivalent QoS-related metadata may be carried using other header fields, container formats, control signaling, per-stream/per-flow identifiers, or other metadata structures associated with the QUIC-based transport and/or MASQUE encapsulation, while still communicating QoS/flow descriptors without requiring a GRE encapsulation layer.

Flow granularity can be preserved by supporting, for example, one GRE tunnel per QFI per child security association (SA) via QUIC/MPQUIC connections. This “one tunnel per QFI per child SA” mapping is exemplary; other mappings are contemplated, including multiplexing multiple QoS flows within one QUIC connection or one MASQUE tunnel (e.g., using distinct streams, connection IDs, or other identifiers), or otherwise selecting a mapping based on overhead reduction, scheduling, and policy enforcement goals.

The URI components for an HTTP/3 request used in the non-3GPP user-plane context may follow the approach described with respect to FIG. 7—e .g., a CONNECT method with a connect-udp/ip MASQUE mode and an HTTPS scheme—while identifying an appropriate target path/authority for the relevant proxy and/or network function endpoint. Meanwhile, the non-3GPP access protocol layers remain untouched as lower transport beneath the MASQUE/QUIC overlay, and MASQUE client/proxy functionality may be incorporated into the UE and UPF so that the UE-side MASQUE functionality forwards PDU sessions toward the UPF while avoiding intermediate encapsulation overhead. In one illustrative expression, instead of GTP-U the transport path may be described as UDP/IP→connect-udp/ip→HTTP 3.0→QUIC/MPQUIC→UDP/IP, while conveying specific UP information over QUIC/MPQUIC and reducing dependency on traditional tunneling.

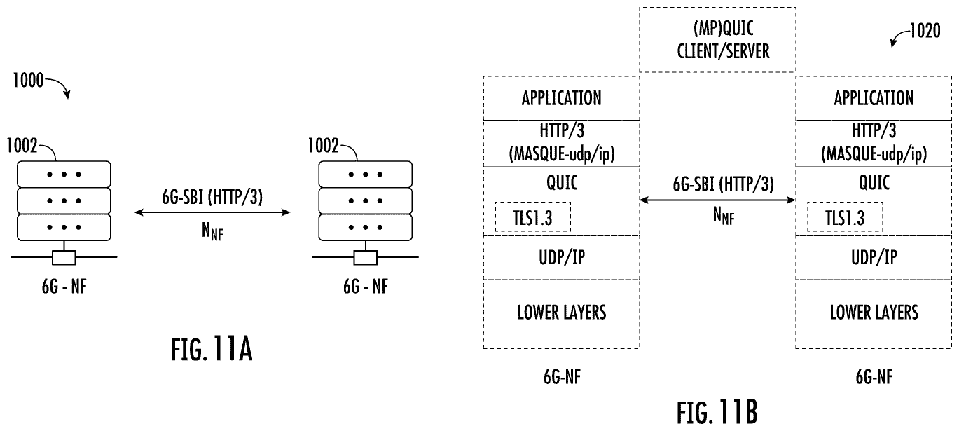

FIG. 11A is a functional block diagram illustrating communication between 6G network functions (NFs) over a service-based interface (SBI) using a QUIC-based transport architecture consistent with the preceding figures. In the illustrated architecture, SBI communications between NFs (e.g., first and second NFs 1002 and 1004) leverage MASQUE client/proxy functionality together with QUIC (optionally multipath QUIC (MPQUIC)) to optimize NF-to-NF data forwarding. In contrast to legacy SBI protocol stacks that use HTTP/2 over TCP with separate TLS, the illustrated approach replaces HTTP/2, TLS, and TCP with a QUIC-based stack that supports multiplexed streams, lower latency, and enhanced security features, thereby reducing latency and inefficiencies associated with TCP connection management and head-of-line blocking.

Lower transport layers such as UDP/IP and below remain unchanged to maintain compatibility with existing infrastructure, while SBI traffic transitions to QUIC/MPQUIC above those layers. For example, SBI communication may follow an illustrative data flow chain of UDP/IP→connect-udp/ip→HTTP 3.0→QUIC/MPQUIC→UDP/IP, enabling secure and efficient NF-to-NF communication without relying on TCP, and enabling applications to be transmitted directly over QUIC/MPQUIC to reduce connection overhead and improve performance.

FIG. 11B is a functional block diagram illustrating protocol stacks of 6G network functions communicating over a service-based interface implemented using MASQUE and QUIC/MPQUIC transport layers. The illustrated protocol stack migration applies across SBI interfaces within 6G networks, including (by way of example) interfaces associated with access and mobility management function (Namf), session management function (Nsmf), application function (Naf), user plane function (Nupf), and others, thereby supporting uniform adoption of QUIC/MPQUIC across the 6G core network to simplify protocol stacks and reduce latency.

The QUIC/MPQUIC-based SBI approach provides reduced latency (e.g., by minimizing handshake delays as compared to TCP-based approaches), supports multiplexed streams so multiple SBI requests may be handled without head-of-line blocking, and provides enhanced security via built-in encryption mechanisms that eliminate a need for separate TLS layers; improved reliability may further be achieved through packet loss recovery and congestion control, and overall architecture simplification results from eliminating TCP and HTTP/2 in the SBI context.

### Methodologies

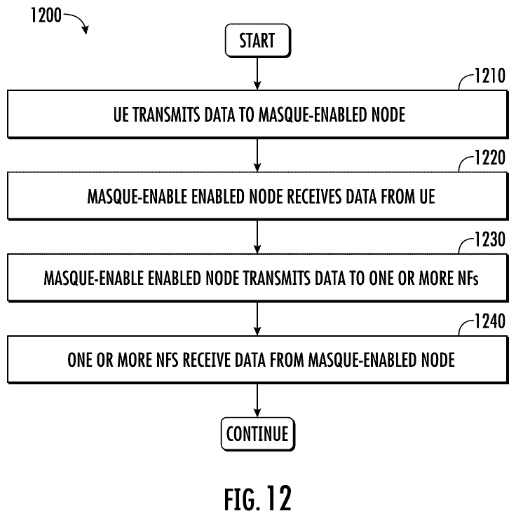

FIG. 12 is a logical flow diagram illustrating one embodiment of a method 1200 enabling data transmission between a user equipment (UE) and one or more network functions (NFs) using MASQUE over QUIC encryption to enable access-agnostic operation, including switching between 3GPP and non-3GPP access without dependency on a particular access type, using MASQUE/QUIC endpoints and tunnels as described herein.

At step 1210, the UE initiates a QUIC connection setup process with at least one MASQUE-enabled node apparatus to establish a secure QUIC data connection, using an HTTP-based protocol such as HTTP/3 over QUIC and UDP/IP for tunneling consistent with MASQUE-enabled endpoints. At step 1220, the MASQUE-enabled node apparatus receives data transmitted from the UE and provides topology hiding and access-agnostic operation, which can include eliminating distinctions between “trusted” and “untrusted” networks by treating non-3GPP access as untrusted (from a 3GPP perspective) to support a unified authentication approach for non-3GPP access.

At step 1230, the MASQUE-enabled node apparatus transmits the received data toward one or more NFs, including control-plane and/or user-plane messages encrypted and routed by QUIC transport to the one or more NFs via SBIs (e.g., N1/N2/N3), with SBI interfaces of NFs based on QUIC/MPQUIC rather than HTTP/2.

At step 1240, the one or more NFs receive the data and continue communications using the service-based architecture, including SBI communications over QUIC/HTTP-3. The method can further include handling of MA-PDUs, replacing legacy protocols in connection setup (e.g., SCTP and/or GTP-U and/or certain security mechanisms) with QUIC/MPQUIC, and including UE-to-AMF specific information in headers associated with QUIC/MPQUIC and NG-AP in certain implementations.

The same process can be used for seamless transition between 3GPP and non-3GPP access in an access-agnostic fashion, leveraging a MASQUE proxy within the 6G core network without requiring interworking functions such as N3IWF/TNGF/W-AGF for non-3GPP access, and encapsulating data traffic through a chain such as UDP/IP→connect-udp/ip→HTTP 3.0→QUIC→UDP to enable direct transmission of NAS-MM and NAS-SM messages to core control-plane functions including a 6G-AMF and 6G-SMF.

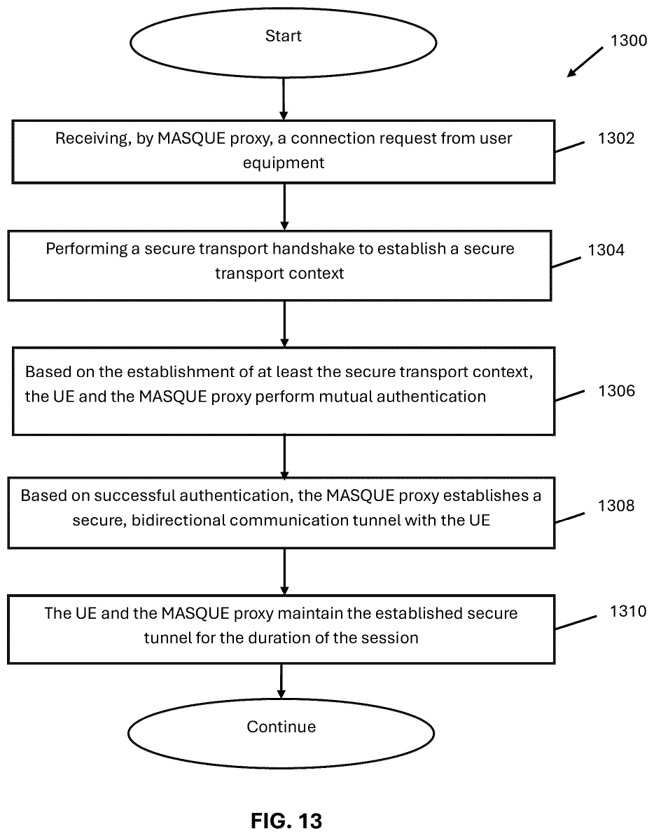

Referring now to FIG. 13, one embodiment of a method 1300 for establishing and maintaining a secure communication tunnel between a user equipment (UE) and a MASQUE-enabled network proxy is shown and described. Method 1300 provides a protocol-agnostic mechanism for enabling secure, bidirectional data transport between a UE and a network proxy using standardized transport and application-layer protocols, without reliance on external tunneling or security frameworks. The method is particularly applicable to network architectures utilizing HTTP/3 and QUIC-based transport, although other transport mechanisms may be substituted consistent with the present disclosure. Further, method 1300 comprises a sequence of coordinated operations between a UE and a MASQUE-enabled proxy to establish an encrypted communication context and to support subsequent transmission of data over a secure tunnel. In one variant, the secure tunnel established by the method 1300 supports multiplexing of multiple logical data flows over a single secure transport session, enabling efficient use of network resources.

At step 1302, the UE initiates a connection establishment phase by transmitting a connection request to the MASQUE proxy. In one implementation, the connection request comprises an HTTP/3 CONNECT request identifying parameters associated with a prospective tunnel session. Such parameters may include, without limitation, identifiers, addressing information, transport configuration data, or other information usable by the proxy to prepare for secure session establishment.

Upon receipt of the connection request, the MASQUE proxy evaluates the request and, in response, prepares to establish a secure transport session with the UE. This preparation may include allocation of connection-related state information, validation of request structure, and readiness to engage in subsequent secure transport negotiation.

In one variant, the method 1300 is implemented in a wireless communication system comprising a cellular UE operating within a next-generation radio access network. In another variant, the UE comprises a non-cellular or multi-access device capable of utilizing multiple access technologies concurrently. Additionally, in one variant, the MASQUE proxy is deployed within a network edge environment, while in another variant the proxy is deployed within a core network, cloud-based infrastructure, or distributed proxy architecture.

At step 1304, the UE and the MASQUE proxy perform a secure transport handshake to establish a secure transport context. In one embodiment, the secure transport handshake is performed using the QUIC protocol operating over HTTP/3. The secure transport context defines transport-layer security parameters, including negotiated cryptographic parameters, that enable confidentiality and integrity protection for packets and streams exchanged between the UE and the proxy.

Establishment of the secure transport context further enables creation of an encrypted communication context between the UE and the MASQUE proxy, under which subsequent tunnel-related signaling and data exchange are protected. The encrypted communication context represents a logical security relationship between the UE and the proxy that is supported by, and operates over, the established secure transport context.

The secure transport handshake may include, without limitation, negotiation of transport parameters, exchange of cryptographic information, and establishment of transport-layer security associations, consistent with applicable transport protocol specifications. The specific signaling sequence and handshake exchanges may vary depending on implementation, network conditions, or deployment configuration.

At step 1306, following establishment of the secure transport context and the associated encrypted communication context, the UE and the MASQUE proxy perform mutual authentication. In one embodiment, mutual authentication is achieved through exchange and verification of authentication credentials associated with the UE and the proxy. Such credentials may be provisioned by a network operator, service provider, or other trusted authority, and may be stored within secure storage associated with the UE or the proxy.

In one variant, the MASQUE proxy validates the identity of the UE based on received credential information, while the UE validates the identity of the MASQUE proxy to confirm that the proxy is authorized to provide the requested tunnel service. Successful completion of the authentication process establishes mutual trust between the communicating entities, thereby permitting continued use of the encrypted communication context for subsequent tunnel establishment and data exchange.

At step 1308, upon successful authentication, the MASQUE proxy establishes a secure, bidirectional communication tunnel with the UE. In one embodiment, the tunnel comprises a MASQUE tunnel implemented over the previously established secure transport session. The tunnel enables encrypted transport of data between the UE and the proxy, including, in some implementations, user plane data, control plane data, or combinations thereof. In one implementation, data transmitted through the tunnel is encapsulated within transport-layer streams associated with the secure session, such that encryption and integrity protection are applied uniformly without requiring separate tunneling or security protocols. The MASQUE proxy may further provide forwarding, relay, or proxying functionality for data received from the UE.

At step 1310, the UE and the MASQUE proxy maintain the established secure tunnel for the duration of the session. In one embodiment, maintaining the tunnel includes preserving an authenticated session state, monitoring transport session validity, and continuing encrypted communication in accordance with the secure transport protocol. Session maintenance may further include handling of mobility events, network changes, or transport-level updates without disrupting the secure tunnel.

The operations of method 1300 are performed by one or more processors executing computer-readable instructions stored in a memory associated with the UE and the MASQUE proxy, respectively. In another implementation, portions of the method are implemented using dedicated hardware, firmware, or combinations thereof.

Accordingly, FIG. 13 illustrates one exemplary method for establishing and maintaining a secure MASQUE-based communication tunnel between a UE and a network proxy using standardized transport protocols, providing a flexible and secure framework for encrypted communication without reliance on external tunneling mechanisms.

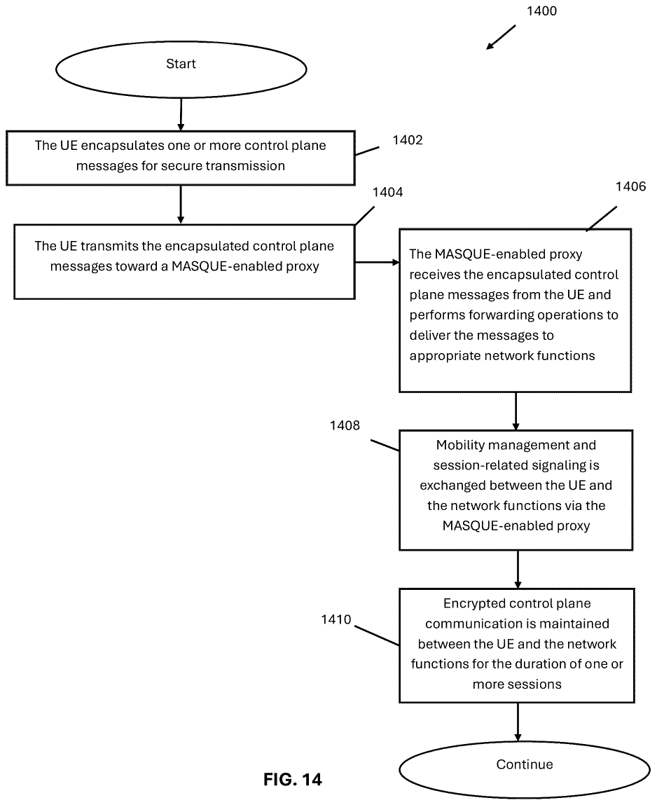

Referring now to FIG. 14, one embodiment of a method 1400 for performing encrypted control plane signaling between a user equipment (UE) and one or more core network functions using a MASQUE-based communication framework is shown and described. In one exemplary aspect, the method 1400 provides a unified mechanism for securely transporting control plane signaling between a UE and network functions using application-layer tunneling over standardized transport protocols. The method enables registration, mobility management, and session management signaling to be conveyed end-to-end over an encrypted communication substrate without reliance on legacy control-plane transport or security mechanisms. Method 1400 comprises a sequence of operations in which control plane signaling generated by a UE is encapsulated, transported, and delivered to one or more network functions via a MASQUE-enabled proxy.

At step 1402, the UE encapsulates one or more control plane messages for secure transmission. In one implementation, the control plane messages include signaling associated with mobility management and session management procedures. Such signaling may comprise, without limitation, messages related to registration, access management, session establishment, session modification, or context maintenance between the UE and the core network.

In one embodiment, encapsulation is performed by a MASQUE client operating at the UE, which prepares the control plane messages for transport within a secure application-layer tunnel. The encapsulated messages are associated with a secure transport session established using HTTP/3 and a QUIC-based transport, such that confidentiality and integrity protection are applied during transmission.

In some variants, the control plane messages transported using method 1400 include signaling traditionally conveyed using access-specific application protocols, while in other variants such signaling is conveyed using application-layer abstractions independent of underlying access technologies.

At step 1404, the UE transmits the encapsulated control plane messages toward a MASQUE-enabled proxy. In one embodiment, transmission occurs over an access network using the established secure transport session. The MASQUE-enabled proxy is configured to terminate secure tunnels initiated by UEs and to provide intermediary forwarding functionality between the UE and the core network.

At step 1406, the MASQUE-enabled proxy receives the encapsulated control plane messages from the UE and performs forwarding operations to deliver the messages to appropriate network functions. In one embodiment, the proxy processes incoming encrypted transport streams, extracts control plane signaling information, and forwards corresponding messages to one or more network functions using service-based interfaces.

Examples of network functions may include, without limitation, functions responsible for access and mobility management or session management. Forwarding operations may be performed over secure application-layer interfaces, such that control plane messages remain protected during transit between the proxy and the network functions.

At step 1408, mobility management and session-related signaling is exchanged between the UE and the network functions via the MASQUE-enabled proxy. In one embodiment, such signaling supports maintenance of UE registration state, mobility context, and session continuity as the UE operates across one or more access networks. The proxy facilitates coordination of signaling exchanges while preserving the secure transport context established between the UE and the network.

At step 1410, encrypted control plane communication is maintained between the UE and the network functions for the duration of one or more sessions. In one embodiment, session management procedures are carried out over the secure MASQUE-based transport, enabling establishment, modification, and release of session-related resources without exposure of control plane signaling to intermediate network elements. The method thereby enables end-to-end encrypted control plane communication using a unified transport framework.

In one variant, the method 1400 is employed in a cellular communication system supporting next-generation radio access technologies. In another variant, the method is used in a multi-access environment in which the UE communicates over both trusted and untrusted access networks.

In one variant, the MASQUE-enabled proxy is deployed at a network edge location to reduce signaling latency, while in another variant the proxy is deployed within a centralized core network environment. In further variants, multiple MASQUE-enabled proxies may cooperate to support scalable signaling delivery.

In one implementation, the operations of method 1400 are performed by one or more processors executing instructions stored in memory at the UE, the MASQUE-enabled proxy, and the network functions, respectively. In other implementations, portions of the method are implemented using dedicated hardware, firmware, or combinations thereof.

Accordingly, FIG. 14 illustrates one exemplary embodiment of a secure control plane signaling method in which registration, mobility management, and session management procedures are performed over a MASQUE-based communication framework using standardized transport protocols. The illustrated method enables encrypted, access-agnostic control plane communication without reliance on legacy signaling transports or external security mechanisms.

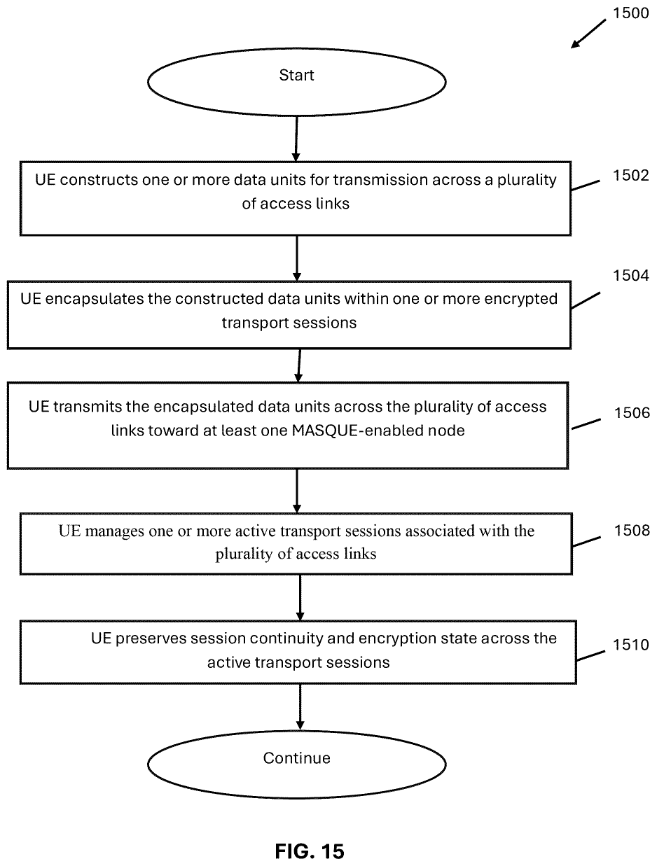

Referring now to FIG. 15, one embodiment of a method 1500 for managing encrypted multi-access data transmission between a user equipment (UE) and a MASQUE-enabled network node is shown and described. In one exemplary aspect, the method 1500 enables access-agnostic, secure data transport across a plurality of heterogeneous access links using a unified application-layer tunneling framework. The method supports concurrent use of multiple access networks while maintaining encryption, session continuity, and transport-level abstraction from underlying link technologies. Method 1500 includes a sequence of operations performed by a UE to prepare, encapsulate, and transmit data across multiple access links toward a MASQUE-enabled node using a secure transport session.

At step 1502, the UE constructs one or more data units for transmission across a plurality of access links. In one implementation, the data units are derived from upper-layer traffic streams and are structured in a manner that is independent of the specific access technologies used for transmission. The data units may represent portions of application data, service data, or other payload information generated by the UE.

In one embodiment, the construction of the data units enables the UE to distribute traffic across multiple access links while presenting a unified data flow to higher protocol layers. The preparation of such data units allows the UE to support concurrent transmission over heterogeneous networks without requiring access-specific handling by applications or services.

At step 1504, the UE encapsulates the constructed data units within one or more encrypted transport sessions. In one embodiment, encapsulation is performed by a MASQUE client operating at the UE, which prepares the data units for transport using HTTP/3 and a QUIC-based transport protocol. The encapsulated data units are associated with secure transport streams such that encryption and integrity protection are applied during transmission. In one variant, multiple data units are multiplexed within a single secure transport session, while in another variant the data units are distributed across multiple transport sessions depending on configuration or network conditions.

At step 1506, the UE transmits the encapsulated data units across the plurality of access links toward at least one MASQUE-enabled node. In one embodiment, each access link operates with independent path characteristics, and the UE transmits data concurrently over multiple links. The MASQUE-enabled node is configured to receive encrypted transport sessions initiated by the UE and to process the received data for forwarding, relay, or delivery to downstream network entities.

In one embodiment, the MASQUE-enabled node performs termination of the secure transport session and provides forwarding functionality while preserving confidentiality of the transmitted data across untrusted or heterogeneous access paths.

At step 1508, the UE manages one or more active transport sessions associated with the plurality of access links. In one embodiment, session management includes maintaining association between data units and transport sessions corresponding to different access paths. In some implementations, the transport protocol supports multipath operation, enabling data to be transmitted across multiple access links while maintaining a unified session context. Session management may further include adaptation to changes in access availability, mobility events, or link conditions, while preserving the established secure transport relationships.

At step 1510, the UE preserves session continuity and encryption state across the active transport sessions. In one embodiment, session continuity is maintained such that encrypted communication persists across changes in access links without requiring re-establishment of application-layer sessions. The secure transport protocol maintains cryptographic state and sequencing information necessary to support uninterrupted data delivery across the plurality of access links.

In one variant, the plurality of access links includes a combination of cellular and non-cellular access networks. In another variant, the access links include wired and wireless communication paths operating simultaneously.

In one variant, the MASQUE-enabled node is deployed at a network edge location, while in another variant the node is deployed within a centralized network infrastructure. In some variants, multiple MASQUE-enabled nodes cooperate to support scalable multi-access data delivery.

In further variants, the method 1500 supports mobility scenarios in which the UE transitions between access networks while maintaining encrypted data sessions.

Accordingly, FIG. 15 illustrates one exemplary method for secure multi-access data transmission using a MASQUE-based communication framework. The method enables encrypted, access-agnostic data transport across multiple heterogeneous links while maintaining session continuity and abstraction from underlying access technologies.

### Apparatus

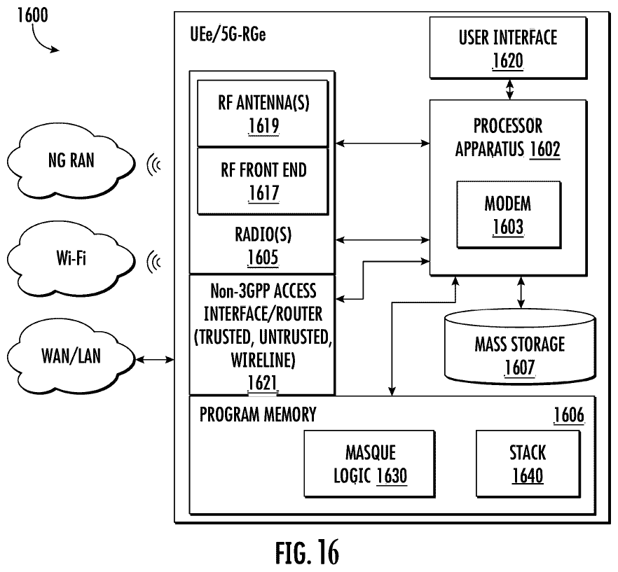

FIG. 16 illustrates a block diagram of an exemplary embodiment of a 6G enabled enhanced user equipment (UEe) apparatus or 5G-RG 1600, useful for operation in accordance with the present disclosure. In one exemplary embodiment as shown, the enhanced UE/5G-RG 1600 includes, inter alia, a processor apparatus or subsystem 1602, a program memory module 1606 which includes MASQUE logic 1630, as well as a protocol stack 1640 encompassing various communication stacks such as 5G, 6G, and Wi-Fi, each implemented as software or firmware operative to execute on the processor 1602.

The UEe/5G-RGe 1600 further comprises wireless radio interface(s) 1605 for communication with relevant radio access networks such as 5G-NR RANs, and network interface(s) 1621 for communication with non-3GPP accesses, which can include trusted, untrusted, or wireline systems applicable to fixed or broadband deployment scenarios. RF interface front ends 1617 and antenna(s) 1619 are each configured to comply with the relevant physical (PHY) standards it supports. Examples of RF front-end components include, without limitation, duplexers, filters, power amplifiers, and low-noise amplifiers. The antenna(s) 1619 of the UEe/5G-RGe radios may include multiple spatially diverse elements implemented in, for example, a Multiple-Input Multiple-Output (MIMO) or Multiple-Input Single-Output (MISO) configuration to enable spatial diversity and improved throughput performance. A phased-array configuration may also be employed to provide enhanced spatial resolution and adaptive beamforming by leveraging time and phase delays among antenna elements to dynamically steer radio beams toward network nodes.

The processor apparatus 1602 is the central computing subsystem responsible for executing all control and data plane features, including digital and baseband signal processing. The processor apparatus is configured to, inter alia, perform sequential and parallel logical operations necessary for MAC, RLC, PDCP, QUIC, and MASQUE protocol handling. Examples of processor architectures may include, without limitation, digital signal processors (DSPs), microprocessors, field programmable gate arrays (FPGAs), graphics processing units (GPUs), or heterogeneous computing systems with multiple cores. The processor apparatus 1602 may further comprise an internal cache memory and an integrated modem/baseband chipset 1603, where the modem 1603 performs modulation, coding, and baseband processing for transmission and reception via the RF front-end module 1617. These components collectively enable the execution of encryption, encapsulation, and tunnel management functions necessary for the MASQUE framework and multi-path QUIC (MP-QUIC) transport across the 6G-AN and the 6G core network.

The program memory module 1606 stores both the MASQUE logic 1630 and the protocol stack 1640, which defines the software framework necessary for executing control and user plane communication across various access types. Examples of program memory may include, without limitation, dynamic random-access memory (DRAM), static random-access memory (SRAM), flash memory, or non-volatile read-only memory (ROM). The memory may further implement direct memory access (DMA) hardware to facilitate low-latency data transfer between interfaces and processing units. In addition, a mass storage device 1607, such as a hard disk drive (HDD), solid-state drive (SSD), or NAND/NOR flash, may be employed to maintain persistent configuration data, MASQUE rule sets, user profiles, and session information.

The MASQUE logic 1630 interacts with the processing subsystem 1602 to support client/proxy functionalities, including topology hiding, encryption management, and mutual authentication between the UEe/5G-RGe and MASQUE proxies (e.g., 6G-AN or 6G-Core). Examples of MASQUE functionality of MASQUE logic 1630 include, without limitation, client proxy negotiation, dynamic QUIC stream creation, and encapsulation of control and user plane data within service-based interfaces (SBIs) such as N1, N2, and N3 links. Data protection across these interfaces is maintained by leveraging QUIC's integrated TLS 1.3 encryption, eliminating the need for dedicated IPSec gateways within the packet core. In some embodiments, the MASQUE logic 1630 may alternatively execute on dedicated hardware accelerators or security coprocessors to enhance processing performance for high-throughput encryption and decryption workloads. Persistent storage of session states and credentials ensures resiliency during handovers or cross-access mobility events.

Communication interfaces within the UEe/5G-RGe 1600 cooperate to facilitate multi-access operation. Wireless radio interfaces 1605 enable 3GPP access through 6G or NR base stations, while the network interfaces 1621 establish wired and non-3GPP access connectivity, which may include Wi-Fi, Ethernet, or DOCSIS systems. The network interface includes circuitry and protocol controllers that enable the physical and logical connection of the UEe/5G-RGe with various network media under standardized communication protocols. Examples of such network interfaces may include, without limitation, Wi-Fi 6/7 chipsets, Ethernet controllers, or broadband gateways. Front-end modules 1617 handle filtering, impedance matching, and duplex switching to isolate received and transmitted channels, while antennas 1619 provide electromagnetic coupling for data transmission across diverse frequencies. The MASQUE client sessions pending on these physical interfaces seamlessly migrate between available networks through cooperative operation between program memory 1606, MASQUE logic 1630, and protocol stack 1640, maintaining end-to-end encrypted tunnel continuity.

During operation, the processor apparatus 1602, MASQUE logic 1630, and protocol stack 1640 collectively coordinate to manage communication sessions, tunnel integrity, and encryption streams across both single-path and multi-path connections. The processor 1602 defines scheduling for MASQUE-based QUIC encapsulation, while memory module 1606 executes stored program instructions for packet routing and congestion control, and network components 1621 and 1605 negotiate active interfaces for optimal throughput or latency. The processor interacts with modem 1603 and RF front end 1617 to modulate traffic based on real-time link metrics, and APIs retrieved from memory 1606 allow network-level orchestration by interacting with MSO-provided applications and the operating system for service optimization. Together, these operations provide the UEe/5G-RGe 1600 with unified, access-agnostic, and low-latency connectivity suitable for 6G deployment environments, enabling secure MASQUE-based transport and integrated support for service-based architectures.

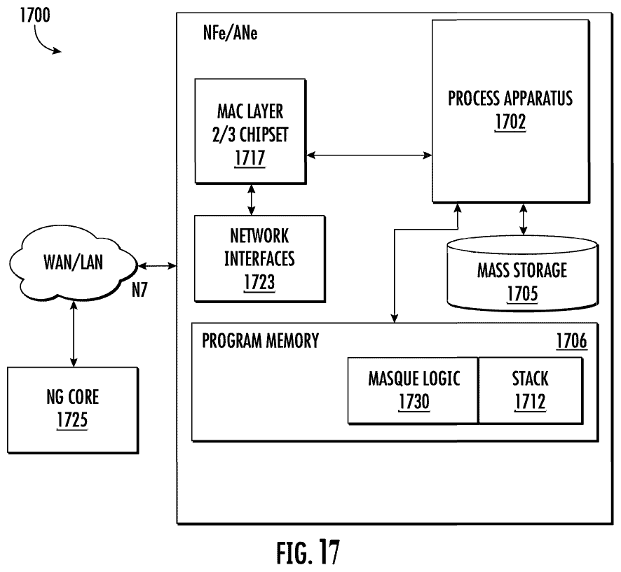

FIG. 17 illustrates a block diagram of an exemplary embodiment of a 6G enabled enhanced NF(NFe)/AN(ANe) apparatus 1700, useful for operation in accordance with the present disclosure. As described herein, the NF may include 5G or 6G network elements such as an access and mobility management function (AMF), a session management function (SMF), a user plane function (UPF), or similar logical entities, while the AN may include 3GPP access such as a 6G radio access network (RAN) or non-3GPP access such as Wi-Fi. In one exemplary embodiment as shown, the NFe/ANe 1700 includes, inter alia, a processor apparatus or subsystem 1702, a program memory module 1706, a local mass storage device 1705, and network interfaces 1723 for communications with the relevant 6G new radio (NR) RAN or other entities such as the 6G core (6GC) and the next generation core (NG Core) 1725. The processor apparatus 1702 is communicatively linked to the memory 1706 and mass storage 1705 to perform coordinated data exchange and execution of MASQUE-based procedures within the 6G system architecture.

The processor apparatus 1702 functions as the central computing subsystem responsible for executing control logic, encryption procedures, and data transfer operations under the MASQUE and QUIC transport framework. The processor apparatus 1702 may incorporate internal cache memory to store frequently accessed data or instructions, improving execution performance and latency. In some embodiments, the processor apparatus 1702 executes computer-executable instructions stored within the program memory 1706 to implement MASQUE logic 1730 and manage the corresponding network protocol stacks 1712, thereby enabling secure, multiplexed tunneling operations throughout the communication pipeline.

The program memory module 1706 serves as a repository for executable code and operational data necessary for the functioning of the NFe/ANe apparatus. Examples of such program memory may include, without limitation, static random-access memory (SRAM), flash memory, and dynamic or synchronous dynamic random-access memory (DRAM/SDRAM), such as GDDR5 or GDDR6 devices. In some variants, the memory 1706 may implement one or more direct memory access (DMA) interfaces to facilitate accelerated data movement between input/output subsystems and processing units. The memory 1706 stores computer-executable instructions forming part of the MASQUE logic 1730 or the 6G protocol stack 1712 for managing control-plane (CP) and user-plane (UP) operations, including service-based interface (SBI) messaging. Application program interfaces (APIs) may also be stored within the memory 1706, facilitating interoperability with external network entities such as the 6G core 1725 or multi-service operator (MSO) headend control nodes through remote procedure invocations or protocol bindings.

The mass storage 1705 operates as a non-volatile persistent storage element, retaining long-term operational configurations and system data. The mass storage 1705 retains system control data such as MASQUE configuration records, policy and routing databases, spectrum allocation profiles, and session state logs. These datasets are accessible by the processor apparatus 1702 or MASQUE logic 1730 for enforcing authentication policies, resource allocation decisions, and routing management tasks that preserve service continuity during dynamic operational conditions.

The MASQUE logic 1730 represents the principal operational module responsible for providing encryption, mutual authentication, and topology hiding in 6G network transactions. The MASQUE logic, inter alia, implements the Multiplexed Application Substrate over QUIC Encryption (MASQUE) protocol for secure tunneling of network traffic. The MASQUE logic 1730 establishes and maintains QUIC-based tunnels between the user equipment (UEe) 1600 and the core network entities through HTTP/3 connect-udp/ip and connect-ip constructs. This logic enables scalable multiplexed communication for both CP and UP data, encrypting and routing messages through QUIC-based service-based interfaces such as N1, N2, and N3. Additionally, MASQUE logic 1730 performs mutual authentication, key exchange, and validation (e.g., certificate validation) with UEe 1600, ensuring persistent end-to-end encrypted communication sessions across both trusted and untrusted network boundaries.

The stack 1712 functions as a protocol suite configured for cross-network interoperability and MASQUE-related transaction management. The stack 1712 operates in conjunction with the MASQUE logic 1730 and processor apparatus 1702 to perform packet scheduling, session synchronization, and error correction procedures. During operation, stack 1712 manages secure communication exchange across multiple network interfaces, ensuring consistent throughput and protocol alignment between nodes operating over distinct physical media.

The MAC layer 2/3 chipset 1717 and network interfaces 1723 collectively enable physical and data-link layer communication between the NFe/ANe 1700 and external network systems. The network interfaces 1723 serve as the access points for WAN/LAN communication with external systems such as the NG Core 1725 or other network devices. Together, these subsystems facilitate reliable QUIC transport, ensuring encrypted, low-latency link-level data exchange under MASQUE-based sessions. These physical interfaces maintain compatibility with high-speed standards to support scalable gigabit or multi-gigabit data flows across 6G access environments.

The NFe/ANe 1700 thus integrates computational, memory, and MASQUE encryption modules into a unified system supporting 6G service-based communications. MASQUE logic 1730 provides secure tunneling, topology concealment, and coordination between the NFe/ANe 1700 and UEe 1600 using QUIC transport over HTTP/3. The integrated architecture offers end-to-end encryption across control and user plane channels while efficiently routing traffic via SBI constructs such as N1, N2, and N3. This configuration enhances network scalability, security, and operational performance by unifying multi-access control and service framework coordination across 6G networks as disclosed herein.

It will be recognized that while certain aspects of the disclosure are described in terms of a specific sequence of steps of a method, these descriptions are only illustrative of the broader methods of the disclosure, and may be modified as required by the application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. This description is in no way meant to be limiting, but rather should be taken as illustrative of the general principles of the disclosure. The scope of the disclosure should be determined with reference to the claims.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

What is claimed is:

1. A computerized method for enabling access-agnostic service connectivity and mobility in a network, the method comprising:
establishing, by a multiplexed application substrate over QUIC encryption (MASQUE)-enabled node apparatus, a QUIC connection with a MASQUE-enabled client device;
receiving, by the MASQUE-enabled node apparatus, data transmitted by the MASQUE-enabled client device over the QUIC connection;
tunneling, by the MASQUE-enabled node apparatus, the data to one or more network functions; and
providing, by the MASQUE-enabled node apparatus, topology hiding such that the one or more network functions are accessible in an access-agnostic manner irrespective of whether access is via a 3GPP access network or a non-3GPP access network.

2. The computerized method of claim 1, wherein the data comprises at least one of control plane data or user plane data.

3. The computerized method of claim 1, wherein the data is encrypted and routed to the one or more network functions using QUIC via service-based interfaces.

4. The computerized method of claim 1, wherein establishing the QUIC connection comprises replacing at least one of stream control transmission protocol, GPRS tunneling protocol user plane, extensible authentication protocol, internet key exchange, or IPSec with multipath QUIC.

5. The computerized method of claim 1, wherein the data comprises a multi-access packet data unit enabling simultaneous connectivity over multiple access networks.

6. The computerized method of claim 1, wherein providing topology hiding eliminates a distinction between trusted and untrusted access networks by treating non-3GPP access as untrusted.

7. The computerized method of claim 1, further comprising removing a generic routing encapsulation layer while retaining quality-of-flow identifier information in user plane data.

8. The computerized method of claim 1, wherein the MASQUE-enabled node apparatus obviates a need for an interworking function.

9. A multiplexed application substrate over QUIC encryption (MASQUE)-enabled client device for use in a network, the MASQUE-enabled client device comprising:
a protocol stack configured to establish a QUIC connection with a MASQUE-enabled node apparatus; and
computerized logic configured to transmit data to the MASQUE-enabled node apparatus over the QUIC connection;
wherein:
the protocol stack comprises a common upper-layer interface usable for both 3GPP access and non-3GPP access, and
the data is tunneled by the MASQUE-enabled node apparatus to one or more network functions in an access-agnostic manner.

10. The MASQUE-enabled client device of claim 9, wherein the protocol stack comprises HTTP, QUIC, and UDP/IP.

11. The MASQUE-enabled client device of claim 9, wherein the client device is configured to participate in a mutual authentication process with the MASQUE-enabled node apparatus.

12. The MASQUE-enabled client device of claim 9, wherein the data comprises control plane signaling or user plane data.

13. The MASQUE-enabled client device of claim 9, wherein the data comprises multi-access packet data units enabling simultaneous connectivity to multiple network functions.

14. The MASQUE-enabled client device of claim 9, wherein the client device is configured to transmit data over at least one of wireline, wireless, or non-terrestrial access.

15. The MASQUE-enabled client device of claim 9, wherein the protocol stack is configured such that security provided by QUIC obviates a need for IPSec.

16. A system for enabling access-agnostic service connectivity and mobility through and between 3GPP and non-3GPP access networks, comprising:
a MASQUE-enabled client device configured to communicate data using a QUIC connection;
at least one MASQUE-enabled node apparatus configured to receive the data from the client device and tunnel the data to one or more network functions; and
the one or more network functions configured to receive the tunneled data;
wherein the MASQUE-enabled node apparatus provides topology hiding such that access to the network functions is agnostic to access type.

17. The system of claim 16, wherein the one or more network functions comprise at least one of an access and mobility management function, session management function, policy control function, location management function, user plane function, or short message service function.

18. The system of claim 16, wherein the MASQUE-enabled node apparatus is disposed within a 3GPP radio access network.

19. The system of claim 16, wherein the MASQUE-enabled node apparatus is disposed within a core network for non-3GPP access.

20. The system of claim 19, wherein the MASQUE-enabled node apparatus obviates a need for a non-3GPP interworking function.

21. The system of claim 16, wherein service-based interface communications between the MASQUE-enabled node apparatus and the one or more network functions use multipath QUIC.

22. The system of claim 16, wherein the QUIC connection replaces at least one of HTTP/2, TLS, or TCP.

23. The system of claim 16, wherein the data comprises a multi-access packet data unit enabling multipath connectivity.

24. The system of claim 16, wherein the MASQUE-enabled client device and the MASQUE-enabled node apparatus are configured to perform mutual authentication.

25. The system of claim 16, wherein topology hiding obviates a need for intra-public land mobile network IPSec gateways.
